(19) United States
(12) Patent Application Publication
(10) Pub. No.: US 2014/0362301 A1
(43) Pub. Date: Dec. 11, 2014

(54) DISPLAY DEVICE AND TELEVISION DEVICE

(71) Applicant: Sharp Kabushiki Kaisha, Osaka-shi, Osaka (JP)

(72) Inventors: Yusuke Masuda, Osaka-shi (JP); Masatoshi Tomomasa, Osaka-shi (JP)

(73) Assignee: Sharp Kabushiki Kaisha, Osaka-shi, Osaka (JP)

(21) Appl. No.: 14/369,761

(22) PCT Filed: Dec. 27, 2012
(86) PCT No.: PCT/JP2012/083792

§ 371 Date: Jun. 30, 2014

(30) Foreign Application Priority Data
Jan. 6, 2012 (JP) 2012-001483

(51) Int. Cl. F21V 8/00; G02F 1/1335; G02F 1/1333

(52) U.S. Cl. CPC G02B 6/0086; G02F 1/133308; G02F 1/133512; G02B 6/005; G02F 2001/133317
USPC 348/836; 349/58; 362/607

(57) ABSTRACT

A liquid crystal display device 10 includes an LED 17, a liquid crystal panel 11, a gate flexible boards 28 connected to an end portion of the liquid crystal panel 11, a light guide plate 16 arranged so as to overlap the liquid crystal panel 11, an optical member 15 arranged between the liquid crystal panel 11 and the light guide plate 16, a holding member HM including a frame 13 and a chassis 14 that hold the liquid crystal panel 11, the optical member 15, and the light guide plate 16, a light blocking portion 23A including a gate flexible board insertion recess 29, and a light restriction portion 30 provided to the optical member 15 and arranged in the gate flexible board insertion recess 29. The light blocking portion 23A blocks light on the outer side thereof from directly entering the end portion of the liquid crystal panel 11. The light restriction portion 30 restricts the light from directly entering the end portion of the liquid crystal panel 11 through the gate flexible board insertion recess 29.

### TECHNICAL FIELD

The present invention relates to a display device and a television device.

### BACKGROUND ART

In recent years, a display element of an image display device such as a television device is shifting from a conventional CRT display device to a thin display device using a thin display element such as a liquid crystal panel and a plasma display panel. This enables the image display device to have a reduced thickness. A liquid crystal panel used for a liquid crystal display device does not emit light, and thus a backlight unit is required as a separate lighting device. Backlight units can be broadly categorized into two types, i.e. a direct-type backlight unit and an edge-type backlight unit, according to its structure. It is preferable to use the edge-type backlight unit to further reduce the thickness of the liquid crystal display device. Patent Document 1 describes a known edge-type backlight unit.

### RELATED ART DOCUMENT

### Patent Document

Patent Document 1: Japanese Unexamined Patent Application Publication No. 2002-174811

### Problem to be Solved by the Invention

In the liquid crystal display device disclosed in Patent Document 1, a liquid crystal panel is sandwiched between a panel holding member arranged on a front side relative to the liquid crystal panel and a panel-receiving member arranged on a rear side relative to the liquid crystal panel. If a demand for a reduction in production cost or in thickness is raised, a configuration without the panel-receiving member on the rear side may be considered. The panel receiving member supports end portions of the liquid crystal panel from the rear side and blocks light from the rear side from entering an end surface of the liquid crystal panel. Therefore, without the panel receiving member, the light from the rear side may enter the end surface of the liquid crystal panel light, i.e., light leakage may occur.

### DISCLOSURE OF THE PRESENT INVENTION

The present invention was made in view of the foregoing circumstances. An object of the present invention is to reduce occurrence of light leakage.

### Means for Solving the Problem

A display device according to the present invention includes alight source, a display panel, a panel connecting member, alight guide plate, an optical member, a holding member, a light blocking portion, and light restriction portion. The display device is configured to provide a display using light from the light source. The panel connecting member is connected to an end portion of the display panel and protrudes from the end portion of the display panel toward the outer side. The light guide plate is arranged to overlap the display panel on a side opposite to a display surface side of the display panel and arranged such that an end surface of the light guide plate is arranged opposite the light source. The optical member is arranged between the display panel and the light guide plate. The holding member includes a pair of holding portions that houses the light source and the panel connecting member and holds the display panel, the optical member, and the light guide plate from the display panel side and the side opposite to the display surface side. The light blocking portion is arranged to range between one of the pair of the holding portions that is on the display surface side and the light guide plate. The light blocking portion is configured to block light on the outer side with respect to the light blocking portion from directly entering the end portion of the display panel. The light blocking portion includes an insertion recess to which the panel connecting member is fitted. The light restriction portion is provided to the optical member and arranged in the insertion recess. The light restriction portion is configured to restrict light that is on the outer side with respect to the light blocking portion from directly entering the end portion of the display panel through the insertion recess.

In this configuration, light emitted from the light source enters the light guide plate through the end surface of light guide plate and travels toward the optical member. While passing through the optical member, the light receives predetermined optical effects. The display panel displays an image using the light. Herein, the display panel, the optical member, and the light guide plate that are arranged to overlap one another are sandwiched by the pair of the holding portions included in the holding member from the display surface side and the side opposite to the display surface side and held thereby. Unlike the conventional display device, a panel receiving member is not arranged between the light guide plate and the optical member and the display panel. Therefore, light may leak to the end portion of the display panel. However, as described above, the light blocking portion is arranged to range between the one of the holding portion arranged on the display surface side and the light guide plate. Thus, the light blocking portion can block at least light located on the outer side with respect to the light blocking portion from directly entering the end portion of the display panel.

The light blocking portion includes the insertion recess through which the panel connecting member that protrudes outward from the end portion of the display panel passes. Therefore, the light outside the light blocking portion may pass through the insertion recess and directly enter a part of the end portion of the display panel to which the panel connecting member is connected. However, as described above, the optical member includes the light restriction portion that is arranged in the insertion recess. Therefore the light restriction portion can restrict the light outside the light blocking portion from passing through the insertion recess and directly entering the contact area of the end portion of the display panel to which the panel connecting member is connected. A light blocking function of the light blocking portion is compensated by the light restriction portion and light leakage to the part of the end portion of the display panel can be appropriately reduced. This improves display quality of the images displayed on the display panel.

The following configurations are preferable as aspects of the present invention.

(1) The light restriction portion may have a size larger than a size of the panel connecting member in a direction along the end portion of the display panel. With this configuration, since the light restriction portion has the size larger than that of the panel connecting member in the direction along the end portion of the display panel, light on the outer side with respect to the light blocking portion is less likely to enter the panel connecting member that is arranged in the insertion recess. Therefore, the light is less likely to enter the part of the end portion of display panel to which the panel connecting member is connected.

(2) The insertion recess may include a first insertion recess to which the panel connecting member is fitted and a second insertion recess to which the light restriction portion is fitted. The second insertion recess may have a size larger than a size of the first insertion recess. The second insertion recess may include a recess edge portion that is in contact with a surface of the light restriction portion facing the panel connecting member. With this configuration, the first insertion recess can be provided with a minimum range within which the panel connecting member can pass through the first insertion recess. Therefore, a light blocking area provided by the light blocking portion can be maximized and a light blocking property can be further enhanced. Further, because the recess edge portion of the second insertion recess through which the light restriction portion passes is in contact with the surface of the light restriction portion on the panel connecting member side, gaps are less likely to occur between the light restriction portion and the recess edge portion of the second insertion recess. Thus, a light restriction property of the light restriction portion is further enhanced.

(3) The light restriction portion may be held between the recess edge portion of the second insertion recess and the light guide plate. With this configuration, gaps are less likely to be generated not only between the light restriction portion and the recess edge portion of the second insertion recess but also between the light restriction portion and the light guide plate. Thus, the light restriction property of the light restriction portion is further enhanced.

(4) An outer end of the light restriction portion may be located on the outer side with respect to a protruded distal end of the panel connecting member. With this configuration, the outer end of the light restriction portion that is arranged on the outer side with respect to the protruded end of the panel connecting member can suitably restrict light on the outer side with respect to the light blocking portion from entering the panel connecting portion in the insertion recess. Thus, light is less likely to enter the part of the end portion of the display panel to which the panel connecting member is connected.

(5) The outer end of the light restriction portion may be located on the outer side with respect to an outer end of the light blocking portion. With this configuration, light on the outer side with respect to the light blocking portion is suitably restricted from entering the insertion recess by the light restriction portion whose outer end is located on the outer side with respect to the outer end of the light blocking portion. Therefore, light is restricted from entering the part of the end portion of the liquid crystal panel to which the panel connecting member is connected.

(6) The light restriction portion may be located on the outer side with respect to the end surface of the light guide plate. With this configuration, the light restriction portion is located on the outer side with respect to the end surface of the light guide plate, and if light leaks light guide plate through the end surface, the light restriction portion suitably restricts the light from entering the insertion recess. Therefore, light is further effectively restricted from entering the part of the end portion of the display panel to which the panel connecting member is connected.

(7) The light restriction portion may have a larger area than the panel connecting member in a view from the display surface side. With this configuration, light located on the outer side with respect to the light blocking portion is suitably restricted from entering the panel connecting member that is in the insertion recess by the light restriction portion having the larger area than the panel connecting member. Therefore, light is further effectively restricted from entering the part of the end portion of the display panel to which the panel connecting member is connected.

(8) The light blocking portion may protrude from the one of the pair of the holding portions arranged on the display surface side toward the light guide plate. A protruded end surface of the light blocking portion may be in contact with the light guide plate. With this configuration, the protruded end surface of the light blocking portion protruding from the holding portion on the display surface side toward the light guide plate is in contact with the light guide plate, and this supports the light guide plate from the display surface side. The light blocking portion includes the insertion recess through which the panel holding member passes, and the light blocking portion and the panel connecting member are aligned in the direction along the end portion of the display panel. Therefore, a space where the light blocking portion is formed can be determined by a protrusion dimension with which the panel connecting member protrudes from the end portion of the display panel can be used. Accordingly, sufficient mechanical strength of the light blocking portion is ensured, and the light guide plate can be stably held with keeping a small frame width of the display device.

(9) The optical member may include a plurality of optical members that are placed on each other. Each of the optical members may include the light restriction portion. In this configuration, each light restriction portion included in each optical member is arranged in the insertion recess. Therefore, an improved high light restriction property is ensured.

(10) The light restriction portion may be integrally included in the optical member as a part thereof. With this configuration, the optical member can be easily produced compared to a case in which the light restriction portion and the optical member are separate parts. This enhances productivity.

(11) The light restriction portion may protrudes from an end of the optical member to the outer side in a cantilever shape. With this configuration, during the mounting operation of the optical member, the optical member is mounted by inserting the light restriction portion through the corresponding insertion recess from an inner side. This improved workability.

(12) The panel connecting member may include a plurality of panel connecting members. The light restriction portion may include a plurality of light restriction portions. The insertion recess may include a plurality of insertion recesses. The panel connecting members, the light restriction portions, and the insertion recesses are arranged at intervals along the end portion of the display panel. A connect portion may be provided on the outer side with respect to the light blocking portion. The connect portion may connect the light restriction portions adjacent to each other. With this configuration, since the adjacent light restriction portions are connected by the connect portion, the light restriction portion is less likely to receive damages, and thus a light restriction performance is properly executed.

(13) The display panel may be a liquid crystal panel including a pair of substrates with liquid crystals sealed therebetween. Such a display device may apply to various applications, such as displays for TVs or personal computers, in particular, for large screens.

### Advantageous Effect of the Invention

According to the present invention, light leakage is less likely to occur.

### BRIEF DESCRIPTION OF THE DRAWINGS

FIG. 1 is an exploded perspective view of a general configuration of a television device and a liquid crystal display device according to a first embodiment of the present invention.

FIG. 2 is a rear view of the television device and the liquid crystal display device.

FIG. 3 is an exploded perspective view of a general configuration of a liquid crystal display unit of the liquid crystal display device.

FIG. 4 is a cross-sectional view of the liquid crystal display device taken along a short-side direction thereof.

FIG. 5 is a cross-sectional view of the liquid crystal display device taken along a long-side direction thereof.

FIG. 6 is a magnified cross-sectional view of the liquid crystal display device. The liquid crystal display device is taken in the short-side direction thereof along a line passing a flexible board (a common screw hole).

FIG. 7 is a magnified cross-sectional view of the liquid crystal display device. The liquid crystal display device is taken in the short-side direction along a line passing a light blocking portion (a heat dissipation member screw hole).

FIG. 8 is a rear view of a liquid crystal panel, an optical member, and a frame.

FIG. 9 is a magnified rear view of the liquid crystal panel, the optical member, and the frame around the light blocking portion and light restriction portions.

FIG. 10 is a cross-sectional view taken along a line x-x in FIG. 9.

FIG. 11 is a cross-sectional view taken along a line xi-xi in FIG. 9.

FIG. 12 is a cross-sectional view taken along a line xii-xii in FIGS. 10 and 11.

FIG. 13 is a cross-sectional view illustrating a cross-sectional configuration of the liquid crystal display device taken along the short-side direction, and illustrating an assembling procedure of components of the liquid crystal display unit that constitutes the liquid crystal display device.

FIG. 14 is a cross-sectional view illustrating a cross-sectional configuration of the liquid crystal display device taken along the long-side direction, and illustrating an assembling procedure of the components of the liquid crystal display unit that constitutes the liquid crystal display device.

FIG. 15 is a cross-sectional view taken along a line xii-xii in FIGS. 10 and 11 illustrating an assembling procedure of the components of the liquid crystal display unit that constitutes the liquid crystal display device.

FIG. 16 is a magnified rear view around a light blocking portion, light restriction portions, and connect portions according to a second embodiment of the present invention.

FIG. 17 is a cross-sectional view taken along a line xvii-xvii in FIG. 16.

FIG. 18 is a cross-sectional view illustrating ranges of a gate flexible board and light restriction portions according to a third embodiment of the present invention.

FIG. 19 is a cross-sectional view illustrating a cross-sectional configuration of an optical member and a light restriction portion according to a fourth embodiment of the present invention.

FIG. 20 is a cross-sectional view taken along a line xx-xx in FIG. 19.

FIG. 21 is a cross-sectional view illustrating a cross-sectional configuration of an optical member and a light restriction portion according to a fifth embodiment of the present invention.

FIG. 22 is a cross-sectional view illustrating a cross-sectional configuration of an optical member and light restriction portions according to a sixth embodiment of the present invention.

FIG. 23 is a cross-sectional view illustrating a cross-sectional configuration of a liquid crystal display device taken along a long-side direction of the liquid crystal display device according to a seventh embodiment of the present invention.

### MODE FOR CARRYING OUT THE INVENTION

### First Embodiment

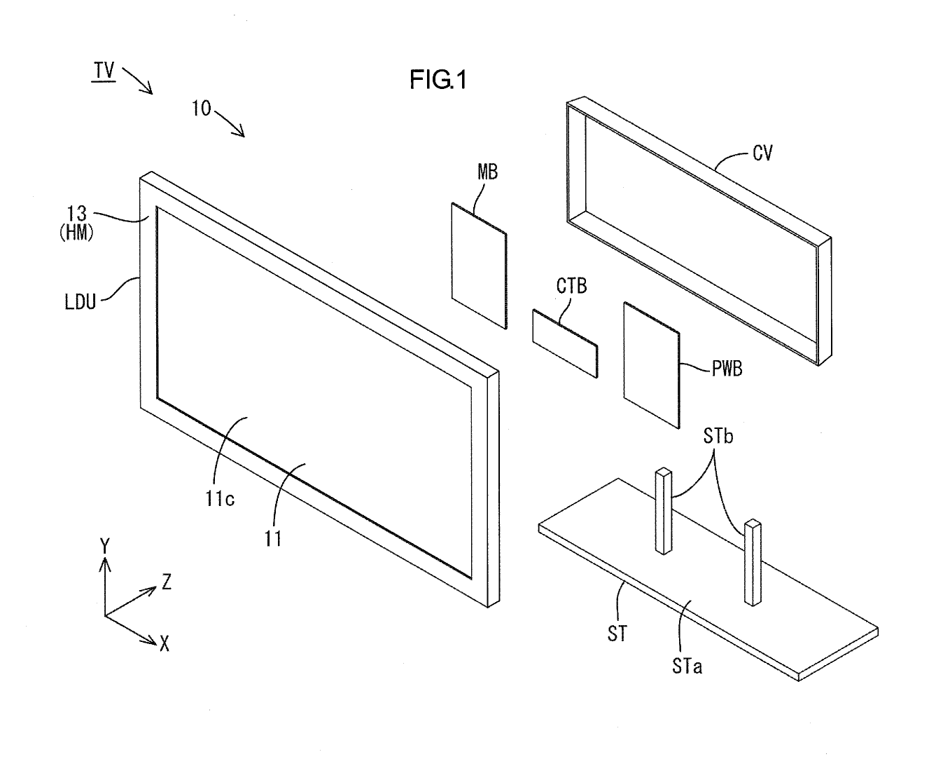

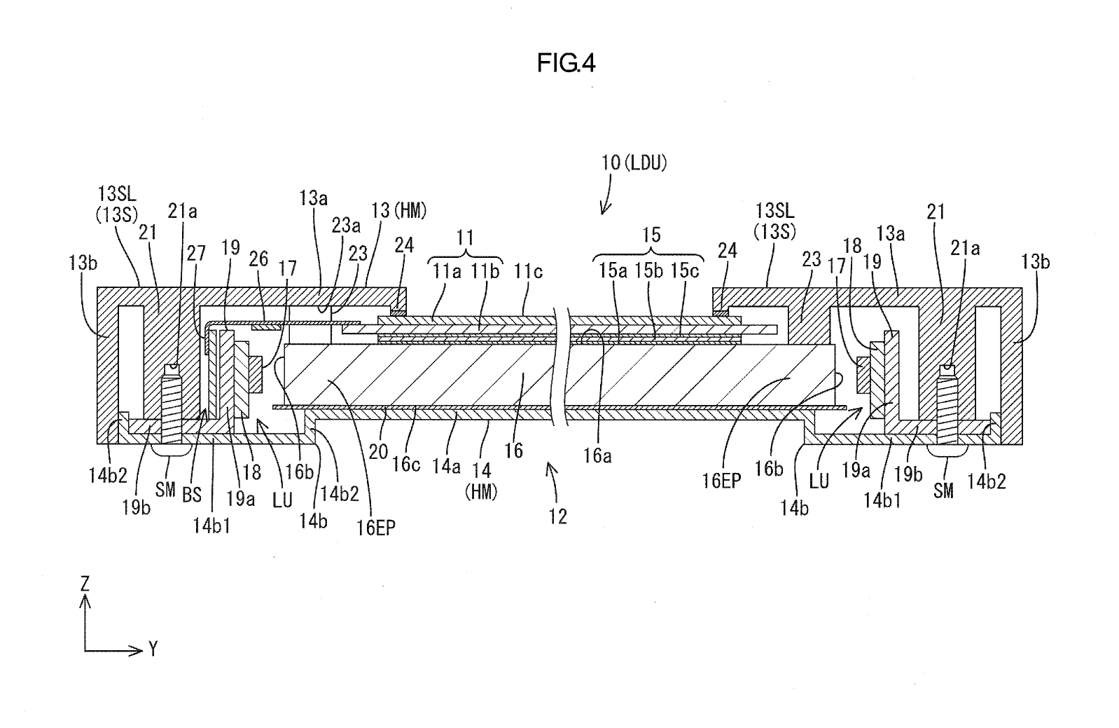

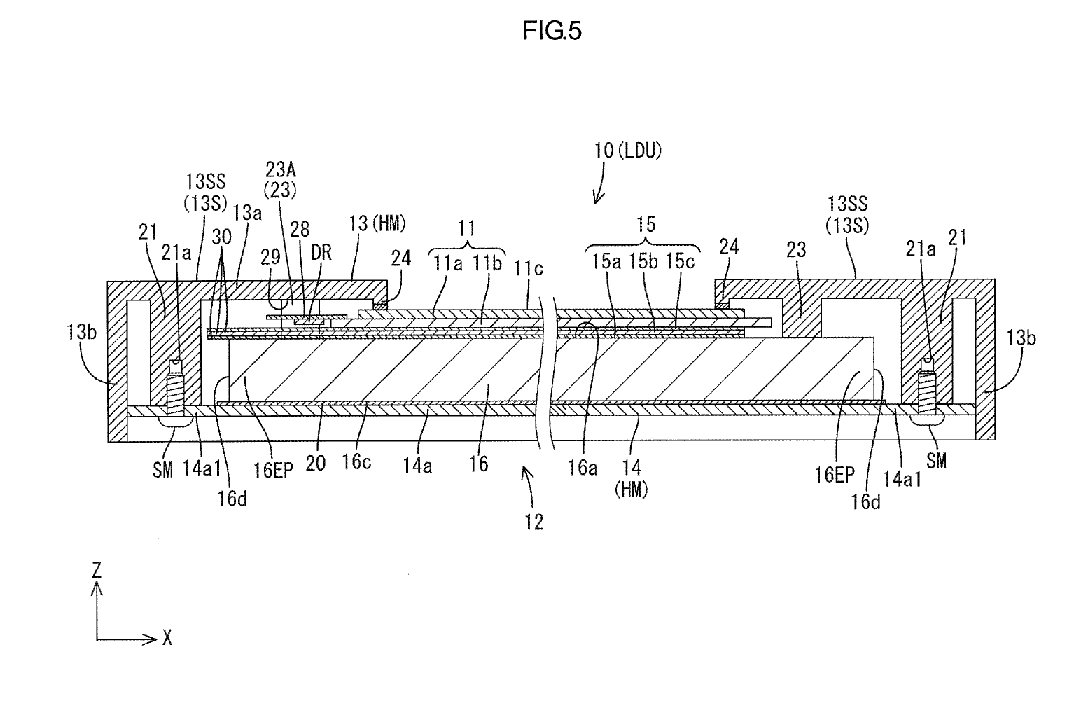

A first embodiment of the present invention will be described with reference to FIGS. 1 to 15. In this embodiment, a liquid crystal display device 10 will be described. X-axis, Y-axis and Z-axis are illustrated in a part of each drawing. The axes in each drawing correspond to the respective axes in other drawings. Upper sides and lower sides in FIGS. 4 and 5 correspond to a front side and a rear side, respectively.

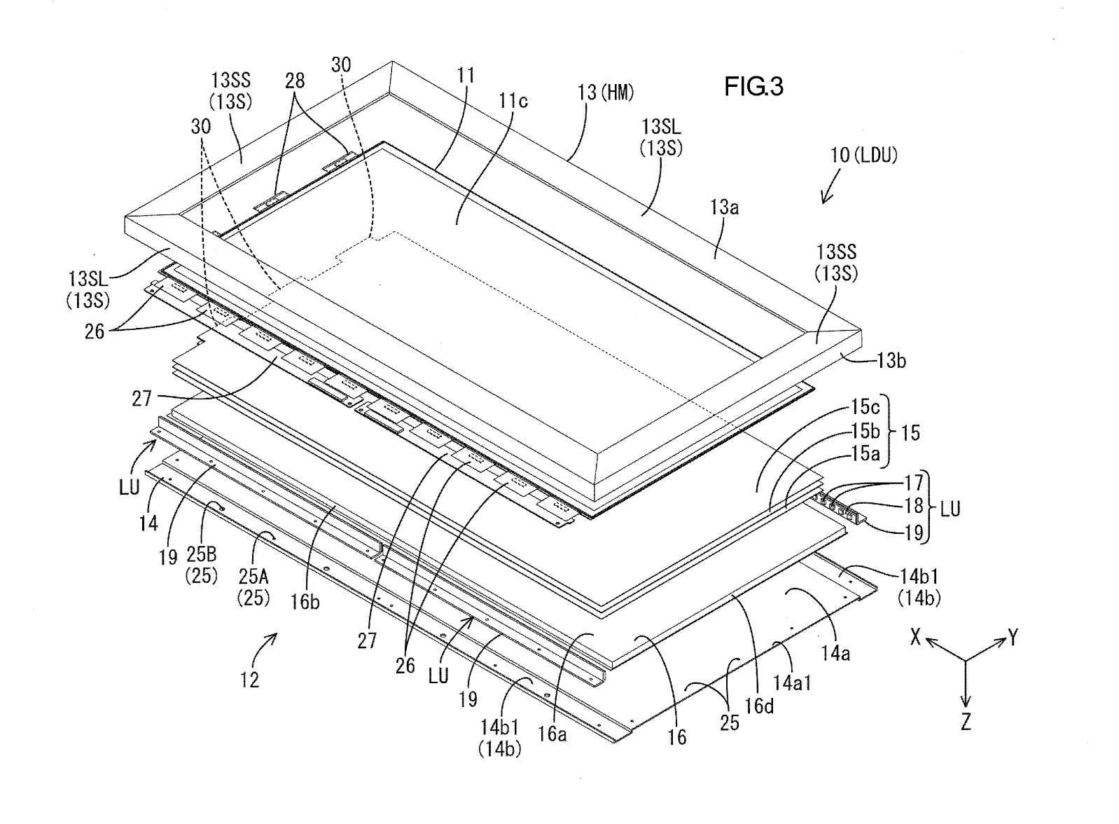

As illustrated in FIG. 1, a television device TV according to this embodiment includes a liquid crystal display unit (a display unit) LDU, boards PWB, MB, and CTB, a cover CV, and a stand ST. The boards PWB, MB, and CTB are attached on a rear surface side (a back surface side) of the liquid crystal display unit LDU. The cover CV is attached on the rear surface side of the liquid crystal display unit LDU so as to cover the boards PWB, MB, and CTB. The stand ST supports the liquid crystal display unit LDU such that a display surface of the liquid crystal display unit LDU extends in the vertical direction (a Y-axis direction). The liquid crystal display device 10 according to this embodiment has the same configuration as the television device TV except for at least a component for receiving television signals (e.g. a tuner included in the main board MB). As illustrated in FIG. 3, the liquid crystal display unit LDU has a landscape rectangular shape (rectangular and longitudinal) as a whole. The liquid crystal display unit LDU includes a liquid crystal panel 11 as a display panel and a backlight unit (a lighting device) 12 as a light source. The liquid crystal panel 11 and the backlight unit 12 are held together by a frame 13 (a holding portion arranged on a display surface 11c side, one holding portion) and a chassis 14 (a holding portion arranged on a side opposite from the display surface 11c, the other holding portion) which are external members that provide an external configuration of the liquid crystal display device 10. The frame 13 and the chassis 14 constitute a holding member HM. The chassis 14 according to this embodiment constitutes not only the external member and a part of the holding member HM but also a part of the backlight unit 12.

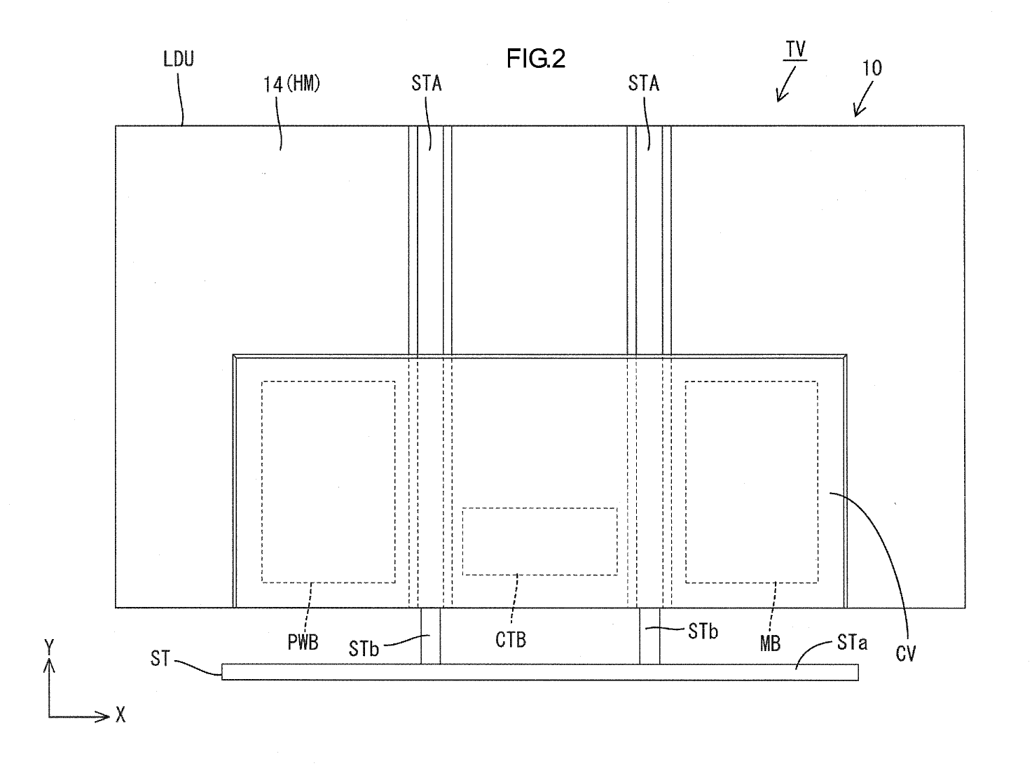

Configurations of the liquid crystal display device 10 on the rear surface side will be described. As illustrated in FIG. 2, stand attachments STA are attached to a rear surface of the chassis 14 that provides an external configuration of the back of the liquid crystal display device 10. The stand attachments STA are away from each other in an X-axis direction and each extend along the Y-axis direction. Each stand attachment STA has a cross section that corresponds to a cross section of a channel beam and is open to the chassis 14. A space is provided between each stand attachment STA and the chassis 14. Support portions STb included in the stand ST are arranged in the spaces provided between the stand attachments STA and chassis 14. The spaces provided inside the stand attachments STA are paths for wiring members (e.g. electric wires) which are connected to LED boards 18 included in the backlight unit 12. The stand ST includes a base STa and the support portions STb. The base STa extends parallel to the X-Z plane. The support portions STb stand on the base STa in the Y-axis direction. The cover CV is made of synthetic resin and attached to a part of the rear surface of the chassis 14. Specifically, as illustrated in FIG. 2, the cover CV covers a lower half part of the chassis 14 so as to cross over the stand attachments STA in the X-axis direction. A component storage space is provided between the cover CV and the chassis 14 such that the boards PWB, MB, and CTB, which will be described next, are stored therein.

As illustrated in FIG. 2, the liquid crystal display device 10 includes a power source board PWB, a main board MB, and a control board CTB as the boards PWB, MB, and CTB. The power source board PWB is a power source of the liquid crystal display device 10 and supplies drive power to the other boards MB and CTB and LEDs 17 included in the backlight unit 12. Namely, the power source board PWB also serves as “an LED drive board (a light source driving board) that drives the LEDs 17.” The main board MB includes at least a tuner and an image processor, which are not illustrated. The tuner is configured to receive television signals. The image processor performs image processing on the received television signals. The main board MB is configured to output the processed image signals to the control board CTB, which will be described next. If an external image reproducing device, which is not illustrated, is connected to the liquid crystal display device 10, image signals from the image reproducing device are input to the main board MB. The image processor included in the main board MB processes the image signals, and the main board MB outputs the processed image signals to the control board CTB. The control board CTB is configured to convert the image signals, which is sent from the main board MB, to driving signals for liquid crystals and to supply the driving signals to the liquid crystal panel 11.

As illustrated in FIG. 3, main components of the liquid crystal display unit LDU included in the liquid crystal display device 10 are arranged in a space provided between the frame (a front frame) 13 that provides a front external configuration and the chassis (a rear chassis) 14 that provides a rear external configuration. The main components arranged between the frame 13 and the chassis 14 are at least the liquid crystal panel 11, an optical member 15, a light guide plate 16, and LED units (light source units) LU. The liquid crystal panel 11, the optical member 15, and the light guide plate 16 are placed on top of one another and held between the frame 13 on the front side and the chassis 14 on the rear side. The backlight unit 12 includes the optical member 15, the light guide plate 16, the LED units LU, and the chassis 14. Namely, the liquid crystal display unit LDU without the liquid crystal panel 11 and the frame 13 is the backlight unit 12. Four LED units LU in total are included in the backlight unit 12 and are arranged in the space between the frame 13 and the chassis 14. Specifically, two LED units LU in a pair sandwich the light guide plate 16 from ends in a short-side direction (the Y-axis direction) of the light guide plate 16, and two LED units LU are arranged on the respective ends along a long-side direction (the X-axis direction) of the light guide plate 16. Each LED unit LU includes LEDs 17 as light sources, the LED board (light source board) 18, and a heat dissipation member (a heat spreader, a light source attachment portion) 19. The LEDs 17 are mounted on the LED board 18. The LED board 18 is attached to the heat dissipation member 19. Each component will be described next.

As illustrated in FIG. 3, the liquid crystal panel has a landscape rectangular shape (rectangular and longitudinal) in a plan view and includes a pair of glass substrates 11a and 11b and liquid crystals. The substrates 11a and 11b each having high light transmissivity are bonded together with a predetermined gap therebetween. The liquid crystals are sealed between the substrates 11a and 11b. One of the substrates 11a and 11b on the front side is a CF substrate 11a and the other one of the substrates 11a and 11b on the rear side (on the backside) is an array substrate 11b. On the array substrate 11b, switching elements (e.g. TFTs), pixel electrodes, and an alignment film are arranged. The switching elements are connected to gate lines and source lines that are arranged perpendicular to each other. The pixel electrodes are connected to the switching elements. Specifically, the TFTs and the pixel electrodes are aligned on the array substrate 11b, and the gate lines and source lines are arranged in a matrix so as to surround the TFTs and the pixel electrodes. The gate lines and the source lines are connected to gate electrodes and source electrodes of the TFTs, respectively. The pixel electrodes are connected to drain electrodes of the TFTs. Capacitor lines (sub capacitor lines, storage capacitor lines, and Cs lines) are arranged on the array substrate 11b so as to be parallel to the gate lines and overlap the pixel electrodes in a plan view. The capacitor lines and the gate lines are alternately arranged in the Y-axis direction. On the CF substrate 11a, color filters, a counter electrode, and an alignment film are arranged. The color filters include red (R), green (G), and blue (B) color portions that are arranged in a predetermined arrangement. Polarizing plates, which are not illustrated, are arranged on outer sides of the substrates 11a and 11b.

As illustrated in FIGS. 4 and 5, the array substrate 11b has a larger size than the CF substrate 11a in a plan view and is arranged such that each end of the array substrate 11b protrudes to an outer side with respect to each end of the CF substrate 11a. Specifically, the array substrate 11b is slightly larger in size than the CF substrate 11a such that an entire outer peripheral end of the array substrate 11b protrudes outwardly from an entire outer peripheral end of the CF substrate 11a. The outer peripheral end of the array substrate 11b includes a pair of long-side ends. In one of long-side end portions of the array substrate 11b that is close to the control board CTB with respect to the Y-axis direction (on a front side in FIG. 3 or on a left side in FIG. 4), source terminals extended from the source lines are arranged. As illustrated in FIG. 3, source flexible boards (panel connecting members, source drivers) 26 are connected to the respective source terminals. The source flexible boards 26 are arranged apart from each other in the X-axis direction, i.e., a direction along the long-side end of the array substrate 11b. Apart of each source flexible board 26 protrudes from the long-side end of the array substrate 11b to the outer side in the Y-axis direction. The outer peripheral end of the array substrate 11b includes a pair of short-side ends. Multiple gate terminals extended from the gate lines and the capacitor lines are arranged in one of short-side end portions of the array substrate 11b (on a far end side in FIG. 3 or on a left side in FIG. 5). Gate flexible boards (panel connecting members, gate drivers) 28 are connected to the respective gate terminals. The gate flexible boards 28 are arranged apart from each other in the Y-axis direction, i.e., a direction along the short-side end of the array substrate 11b. A part of each gate flexible board 28 protrudes to an outer side with respect to the short-side end of the array substrate 11b in the X-axis direction.

As illustrated in FIG. 3, each of the flexible boards 26 and 28 includes a film-like base and a driver (a panel driving component) DR for driving the liquid crystals. The base is made of synthetic resin that has an insulation property and flexibility such as polyimide resin. Traces (not illustrated) are arranged on the base and connected to the driver DR that is mounted on about a center of the base. One end of each source flexible board 26 is pressed and connected to each source terminal of the array substrate 11b via an anisotropic conductive film (ACF). Another end of each source flexible board 26 is pressed and connected to each terminal of a printed circuit board 27, which will be described later, via another anisotropic conductive film. The printed circuit board 27 is connected to the control board CTB via a wiring member, which is not illustrated, and thus signals from the control board CTB (scanning signals to the gate lines, data signals to the source lines, and capacitor signals to the capacitor lines) are transmitted to the source flexible boards 26. One end of each gate flexible board 28 is pressed and connected to each gate terminal of the array substrate 11b via another anisotropic conductive film. Relay lines (not illustrated) that connect the source terminals and gate terminals are arranged on the array substrate 11b. Through the relay lines, the signals (e.g. the scanning signals to the gate lines and the capacitor signals to the capacitor line) are transmitted from the source flexible boards 26 and the source terminals to the gate terminals and the gate flexible boards 28. The liquid crystal panel 11 thus displays images on the display surface 11c according to the signals from the control board CTB.

As illustrated in FIGS. 4 and 5, the liquid crystal panel 11 is placed on a front side (a light exit side) of the optical member 15. A rear surface of the liquid crystal panel 11 (a rear surface of the polarizing plate on the rear side) is fitted to the optical member 15 with minimal gaps threrebetween. Therefore, dust is less likely to enter the gaps between the liquid crystal panel 11 and the optical member 15. The display surface 11c in the liquid crustal panel 11 includes a display area and a non-display area. The display area is an inner area of a screen in which images are displayed. The non-display area is an outer area of the screen around the display area and has a frame-like shape. The terminals and the flexible boards 26 and 28 described earlier are arranged in the non-display area.

As illustrated in FIG. 3, similar to the liquid crystal panel 11, the optical member 15 has a landscape rectangular shape in a plan view and has a size (a short-side dimension and a long-side dimension) slightly smaller than that of the liquid crystal panel 11. The optical member 15 is placed on the front side (the light exit side, the liquid crystal panel 11 side) of the light guide plate 16, which will be described later, and sandwiched between the light guide plate 16 and the liquid crystal panel 11. The optical member 15 includes three sheets placed on top of one another. Specifically, the optical member 15 includes a diffuser sheet 15a, a lens sheet (a prism sheet) 15b, and a reflecting type polarizing sheet 15c and arranged in this sequence from the rear side (the light guide plate 16 side). Each of the three sheets 15a, 15b, and 15c has the substantially same size in a plan view.

The diffuser sheet 15a that is arranged on a rearmost side (an opposite side from the light exit side, the light guide plate 16 side) of the three sheets includes a sheet-like base member that is made of substantially transparent (high light transmissive) synthetic resin and contains light diffusing particles with being dispersed therein. Light is diffused by the diffuser sheet 15a while passing therethrough. The lens sheet 15b arranged in a middle in an overlaid direction (the Z-axis direction) of the three sheets includes a sheet-like base member made of substantially transparent synthetic resin and a prism layer overlaid on a plate-surface of the base member. Light passing through the lens sheet 15b is collected by the lens sheet 15b. The reflection type polarizing sheet 15c arranged on a front-most side (the light exit side, the liquid crystal panel 11 side) of the three sheets has a multi-layer structure including layers each having different light-refractive index that are alternately placed on the top of one another, for example. In this configuration, among rays of light from the light guide plate 16, p-polarized waves of light pass through the reflection type polarizing sheet 15c and s-polarized waves of light reflect off the reflection type polarizing sheet 15c and return toward the light guide plate 16. The s-polarized waves of light that return toward the light guide plate 16 reflect off a light guide reflection sheet 20, which will be described later, toward the front side. The light reflecting off the light guide reflection sheet 20 including the s-polarized waves of light and p-polarized waves of light travels toward the reflection type polarizing sheet 15c. The light travelling toward the reflection type polarizing sheet 15c is used again and this improves the light utilization efficiency (brightness).

The light guide plate 16 is made of substantially transparent (high transmissivity) synthetic resin (e.g. acrylic resin or polycarbonate such as PMMA) that has a refractive index sufficiently higher than that of the air. As illustrated in FIG. 3, the light guide plate 16 has a landscape rectangular shape in a plan view similar to the liquid crystal panel 11 and the optical member 15. A thickness of the light guide plate 16 is larger than a thickness of the optical member 15. A long-side direction and a short-side direction of a main surface of the light guide plate 16 correspond to the X-axis direction and the Y-axis direction, respectively. A thickness direction of the light guide plate 16 that is perpendicular to the main surface of the light guide plate 16 corresponds to the Z-axis direction. As illustrated in FIGS. 4 and 5, the light guide plate 16 has a size (a short-side dimension and a long-side dimension) larger than those of the liquid crystal panel 11 and the optical member 15 in a plan view. The light guide plate 16 is arranged such that end portions 16EP of the light guide plate 16 each protrude to an outer side with respect to each end of the liquid crystal panel 11. Specifically, the light guide plate 16 is slightly larger than the liquid crystal panel 11 such that the end portions 16EP as a whole protrude to an outer side with respect to the outer peripheral portion of the array substrate 11b of the liquid crystal panel 11. The light guide plate 16 is arranged on the rear side of the optical member 15 and sandwiched between the optical member 15 and the chassis 14. The LED units LU are arranged on each end in the short-side direction of the light guide plate 16 so as to have the light guide plate 16 between the LED units LU in the Y-axis direction. Light from the LEDs 17 enters the light guide plate 16 through the ends in the short-side direction. The light guide plate 16 is configured to guide the light, which is from the LEDs 17 and enters the light guide plate 16 through the ends in the short-side direction, toward the optical member 15 (on the front side). One reason why the light guide plate 16 has the size larger than those of the liquid crystal panel 11 and the optical member 15 (the reason to provide the end portion EP) is to provide a sufficient distance for which the light travels inside the light guide plate 16. Accordingly, uneven brightness is less likely to occur in the light exiting the light guide plate 16. Another reason is that the light exiting the light guide plate 16 from the end portions EP is more likely to be uneven compared to the light exiting the light guide plate 16 from a middle portion thereof. If the light exiting the light guide plate 16 from the end portions 16EP is used for displaying an image, the display quality may be lowered.

As illustrated in FIG. 4, one of plate surfaces (the main surfaces) of the light guide plate 16 that faces the front side (a surface opposite the optical member 15) is a light exit surface 16a. Light exits the light guide plate 16 through the light exit surface 16a toward the optical member 15 and the liquid crystal panel 11. The light guide plate 16 include outer peripheral end surfaces that are adjacent to the plate surfaces of the light guide plate 16, and two end surfaces thereof each extend in the X-axis direction are elongated long-side surfaces (end surfaces in the short-side direction). Each long-side surface is opposite the LEDs 17 (the LED boards 18) with a predetermined space therebetween and serves as light entrance surfaces 16b through each of which light from LEDs 17 enters. The light entrance surfaces 16b are parallel to the X-Z plane (main surfaces of the LED boards 18) and substantially perpendicular to the light exit surface 16a. An arrangement direction of the LED 17 and the light entrance surface 16b corresponds to the Y-axis direction and parallel to the light exit surface 16a. Since the light entrance surfaces 16b are opposite the LEDs 17, the light entrance surfaces 16b may be referred to as “LED opposed surfaces (the light source opposed surfaces).” The outer peripheral end surfaces of the light guide plate 16 that are adjacent to the plate surface of the light guide plate 16 include elongated short-side end surfaces (end surfaces included in end portions of the light guide plate 16 with respect to the long-side direction) that extend in the Y-axis direction. The short-side end surfaces are LED non-opposed surfaces (light source non-opposed surfaces) 16d that are not opposite the LEDs 17. One of the end portions 16EP of the light guide plate 16 that include the LED non-opposed surfaces 16d, that is, the short-side end portion 16EP overlaps the gate flexible boards 28 in a front view.

As illustrated in FIGS. 4 and 5, the light guide reflection sheet (a reflection member) 20 is arranged on the rear side of the light guide plate 16, i.e., a plate surface 16c opposite to the light exit surface 16a (a surface opposite the chassis 14). Light that travels toward the rear outside through the plate surface 16c is reflected by the light guide reflection sheet 20 toward the front side. The light guide reflection sheet 20 is arranged to cover an entire area of the plate surface 16c. The light guide reflection sheet 20 is arranged between the chassis 14 and the light guide plate 16. The light guide reflection sheet 20 is made of synthetic resin and has a white surface having high light reflectivity. As illustrated in FIG. 4, at least a short-side dimension of the light guide reflection sheet 20 is larger than that of the light guide plate 16. The light guide reflection sheet 20 is arranged such that ends in the short-side direction thereof protrude closer to the LEDs 17 compared to the light entrance surfaces 16b of the light guide plate 16. Light that travels from the LEDs 17 toward the chassis 14 at an angle is effectively reflected toward the light entrance surfaces 16b of the light guide plate 16 by the protruded portions (the long-side ends) of the light guide reflection sheet 20. At least one of the light exit surface 16a and the plate surface 16c opposite to the light exit surface 16a of the light guide plate 16 has a reflection portion (not illustrated) or a scattering portion (not illustrated). The reflection portion is configured to reflect the light inside the light guide plate 16. The scattering portion (not illustrated) is configured to scatter the light inside the light guide plate 16. The reflection portion or the scattering portion may be formed by patterning so as to have a specified in-plane distribution. This configuration regulates the light from the light exit surface 16a to have an even in-plane distribution.

Next, a configuration of each of the LEDs 17, the LED board 18, and the heat dissipation member 19 included in the LED unit LU will be described. As illustrated in FIGS. 3 and 4, each LED 17, which is included in the LED unit LU, includes an LED chip arranged on a board that is fixed on the LED board 18 and sealed with resin. The LED chip mounted on the board has one main light emission wavelength. Specifically, the LED chip that emits light in a single color of blue is used. The resin that seals the LED chip contains phosphors dispersed therein. The phosphors emit light in a predetermined color when excited by blue light emitted from the LED chip. Thus, overall color of light emitted from the LED 17 is white. The phosphors may be selected, as appropriate, from yellow phosphors that emit yellow light, green phosphors that emit green light, and red phosphors that emit red light. The phosphors may be used in combination of the above phosphors. The LED 17 includes a main light-emitting-surface 17a that is opposite to a surface on which the LED board 18 is mounted (a surface opposite the light entrance surfaces 16b of the light guide plate 16). Namely, the LED 17 is a top-surface-emitting type LED.

As illustrated in FIGS. 3 and 4, each LED board 18 included in the LED unit LU has an elongated plate-like shape and extends in the long-side direction of the light guide plate 16 (the X-axis direction, the long-side direction of the light entrance surface 16b). The LED boards 18 are arranged in a space between the frame 13 and the chassis 14 such that a plate surface of each LED board 18 is parallel to the X-Z plane, i.e., parallel to the light entrance surface 16b of the light guide plate 16. Each LED board 18 has a long-side dimension that is about a half of the long-side dimension of the light guide plate 16. The LED board 18 includes a mount surface 18a on which the LEDs 17 are surface-mounted. The mount surface 18a is a plate surface that faces inward, namely, a plate surface of the LED board 18 that faces the light guide plate 16 (the surface opposite the light guide plate 16). The LEDs 17 are arranged in line (i.e., linearly) at intervals on the mount surface 18a of the LED board 18 along the long-side direction of the LED board 18 (the X-axis direction). In other words, multiple LEDs 17 are arranged away from each other in the long-side direction of the backlight unit 12 along the long sides of the backlight unit 12. Distances between the adjacent LEDs 17 in the X-axis direction are substantially equal, that is, the LEDs 17 are arranged at substantially equal intervals. An arrangement direction of the LEDs 17 corresponds to the longitudinal direction of the LED board 18 (the X-axis direction). A Metal-film trace (not illustrated), such as copper-foil trace, is formed on the mount surface 18a of the LED board 18. The metal-film trace extends in the X-axis direction and crosses over a group of the LEDs 17 so as to connect the adjacent LEDs 17 in series. Terminals at ends of the trace are electrically connected to the power source board PWB via wiring members including connecters and electric wires. Thus, driving power is supplied to the LEDs 17. The LED boards 18 in a pair that are arranged so as to sandwich the light guide plate 16 therebetween are arranged in the spaces between the frame 13 and the chassis 14 such that the mount surfaces 18a on which the LEDs 17 are mounted face each other. The main light-emitting-surfaces 17a of the LEDs 17 on one of the LED boards 18 face the main light-emitting-surfaces 17a of the LEDs 17 on the other one of the LED boards 18. A light axis of each LED 17 is substantially corresponds to the Y-axis direction. A substrate of each LED board 18 is made of metal such as aluminum. Traces (not illustrated) are formed on the surface of the LED board 18 via an insulating layer. A material used for LED boards 18 may be an insulating material including ceramic.

As illustrated in FIGS. 3 and 4, the heat dissipation member 19 included in each LED unit LU is made of metal having high thermal conductivity, such as aluminum. The heat dissipation member 19 includes an LED attachment portion (light source attachment portion) 19a and a heat dissipation portion 19b. The LED board 18 is attached on the LED attachment portion 19a. The heat dissipation portion 19b is in plane-contact with a plate surface of the chassis 14. The LED attachment portion 19a and the heat dissipation portion 19b form an angle therebetween so as to have an L-like shape in a cross-section. The heat dissipation member 19 has a long-side dimension substantially equal to the long-side dimension of the LED board 18. The LED attachment portion 19a of the heat dissipation member 19 has a plate-like shape parallel to the plate surface of the LED board 18 and the light entrance surface 16b of the light guide plate 16. A long-side direction, a short-side direction, and a thickness direction of the LED attachment portion 19a are aligned with the X-axis direction, the Z-axis direction, and the Y-axis direction, respectively. The LED board 18 is mounted on an inner surface of the LED attachment portion 19a, that is, a plate surface that faces the light guide plate 16. While the LED attachment portion 19a has a long-side dimension that is substantially equal to the long-side dimension of the LED board 18, a short-side dimension of the LED attachment portion 19a is larger than a short-side dimension of the LED board 18. Therefore, ends of the LED attachment portion 19a in the short-side direction protrude to an outer side with respect to the LED board 18 in the Z-axis direction. An outer plate surface of the LED attachment portion 19a, that is, a plate surface opposite to the plate surface on which the LED board 18 is attached, faces a screw attachment portion 21 (a fixing member attachment portion) included in the frame 13, which will be described later. The LED attachment portion 19a is located between the screw attachment portion 21 of the frame 13 and the light guide plate 16. The LED attachment portion 19a rises from an inner end of the heat dissipation portion 19b, i.e., an end of the heat dissipation portion 19b on the LEDs 17 (the light guide plate 16) side, toward the front side in the Z-axis direction (a direction in which the liquid crystal panel 11, optical member 15, and the light guide plate 16 overlap each other), i.e., toward the frame 13.

As illustrated in FIGS. 3 and 4, the heat dissipation portion 19b has a plate-like shape and is parallel to the plate surface of the chassis 14. A long-side direction, a short-side direction, and a thickness direction of the heat dissipation portion 19b are aligned with the X-axis direction, the Y-axis direction, and the Z-axis direction, respectively. The heat dissipation portion 19b extends from a rear-side end of the LED attachment portion 19a toward the outer side in the Y-axis direction. In other words, the heat dissipation portion 19b extends from an end of the LED attachment portion 19a closer to the chassis 14 toward a counter direction from the light guide plate 16. The heat dissipation portion 19b has a long-side dimension substantially equal to the long-side dimension of the LED attachment portion 19a. An entire rear plate surface of the heat dissipation portion 19b, i.e., a plate surface of the heat dissipation portion 19b facing the chassis 14, is in contact with the plate surface of the chassis 14. A front plate surface of the heat dissipation portion 19b, i.e., a plate surface opposite from the surface in contact with the chassis 14, faces the screw attachment portion 21 of the frame 13, which will be described later. Specifically, the front plate surface of the heat dissipation portion 19b is in contact with a projected end surface of the screw attachment portion 21. The heat dissipation portion 19b is sandwiched between the screw attachment portion 21 of the frame 13 and the chassis 14. With this configuration, heat generated by the lightened LEDs 17 is transferred to the chassis 14 and the frame 13 including the screw attachment portion 21 via the LED board 18, the LED attachment portion 19a, and the heat dissipation portion 19b. Therefore, heat is effectively released to the outside of the liquid crystal display device 10 and thus the heat is less likely to stay therein. The heat dissipation portion 19b includes through holes 19b1 through which screw member (fixing members) SM are passed. The heat dissipation portion 19b is fixed to the screw attachment portion 21 with the screw members SM.

Next, configurations of the frame 13 and the chassis 14 that constitute the external members and the holding member HM will be described. The frame 13 and the chassis 14 are made of metal such as aluminum so as to have mechanical strength (rigidity) and thermal conductivity compared to a frame 13 and a chassis 14 made of synthetic resin. In other words, the material of the frame 13 and the chassis 14 is light blocking material having a light blocking property. As illustrated in FIG. 3, while the LED units LU are arranged in the space between the frame 13 and the chassis 14 along each end of the frame 13 and the chassis 14 in the short-side direction (the long-side ends), the frame 13 and the chassis 14 hold the liquid crystal panel 11, the optical member 15, and the light guide plate 16, which are placed on top of the other, from the front side and the rear side.

As illustrated in FIG. 3, the frame 13 has a landscape rectangular shape so as to surround the display area in the display surface 11c of the liquid crystal panel 11. The frame 13 includes panel holding portions 13a and sidewalls 13b. Each panel holding portion 13a is parallel to the display surface 11c of the liquid crystal panel 11 and presses the liquid crystal panel 11 from the front side. Each sidewall 13b protrudes from an outer peripheral portion of each panel holding portion 13a toward the rear side. Each of the panel holding portion 13a and the sidewall 13b form an L-like shape in a cross-section. The panel holding portions 13a form a landscape-rectangular and frame-like shape as a whole that correspond to an outer peripheral portion (the non-display area, a frame-like portion) of the liquid crystal panel 11. The panel holding portions 13a press a substantially entire area of the outer peripheral portion of the liquid crystal panel 11 from the front side. The panel holding portion 13a has a width that is large enough to cover not only the outer peripheral portion of the liquid crystal panel 11 but also the outer peripheral portions of the light guide plate 16 and the LED units LU from the front side. The outer peripheral portions of the optical member 15 and the light guide plate 16 and the LED units LU are located on the outer side with respect to the outer peripheral portion of the liquid crystal panel 11 in a radiation direction. Similar to the display surface 11c of the liquid crystal panel 11, a front exterior surface (a surface opposite to the surface facing the liquid crystal panel 11) of each panel holding portion 13a is seen from the front side of the liquid crystal display device 10. The panel holding portions 13a constitute a front exterior of the liquid crystal display device 10 together with the display surface 11c of the liquid crystal panel 11. Each sidewall 13b protrudes from the outer peripheral portion of each panel holding portion 13a toward the rear side. The sidewalls 13b form a substantially rectangular hollow shape as a whole. The sidewall 13b entirely surrounds the liquid crystal panel 11, the optical member 15, the light guide plate 16, and the LED units LU, which are arranged in the space between the frame 13 and the chassis 14, in a peripheral direction thereof. The sidewalls 13b surround the chassis 14 as a whole which is on the rear side, in a peripheral direction thereof. Outer surfaces of the sidewalls 13b that extend in the peripheral direction of the liquid crystal display device 10 face outside of the liquid crystal display device 10. Therefore, the outer surfaces of the sidewalls 13b constitute a top surface, a bottom surface, and side surfaces of the liquid crystal display device 10.

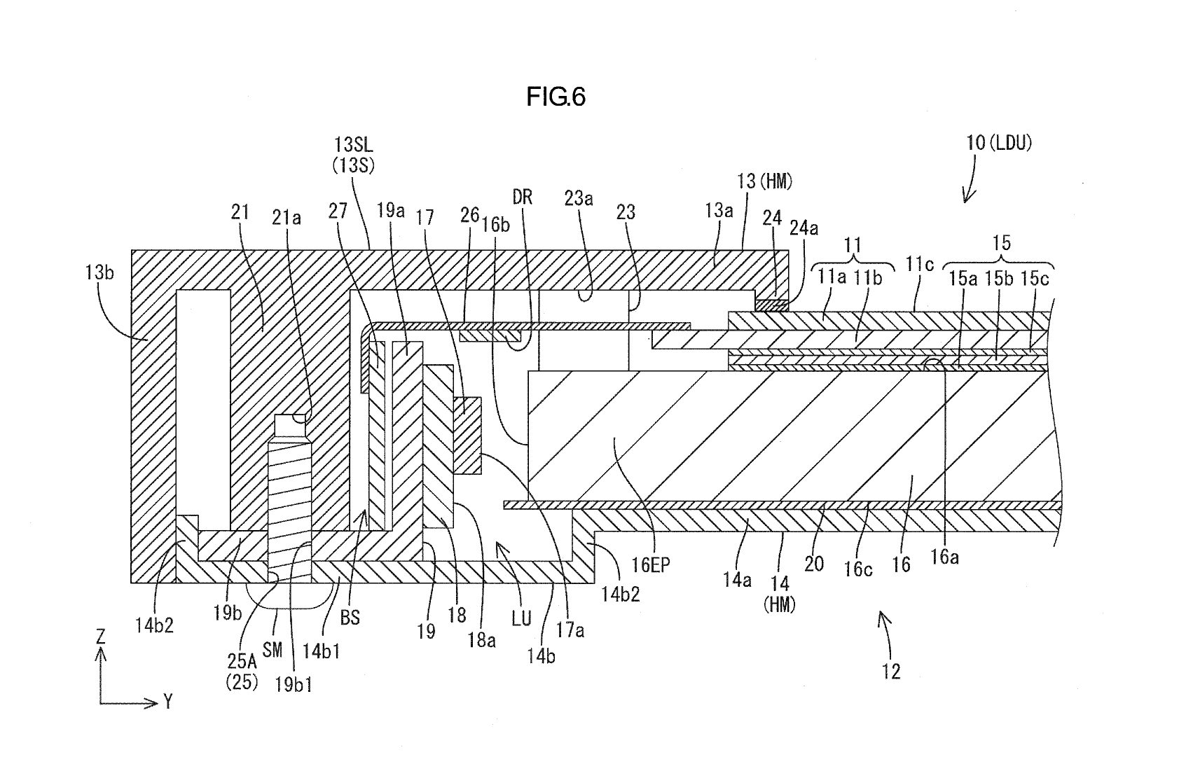

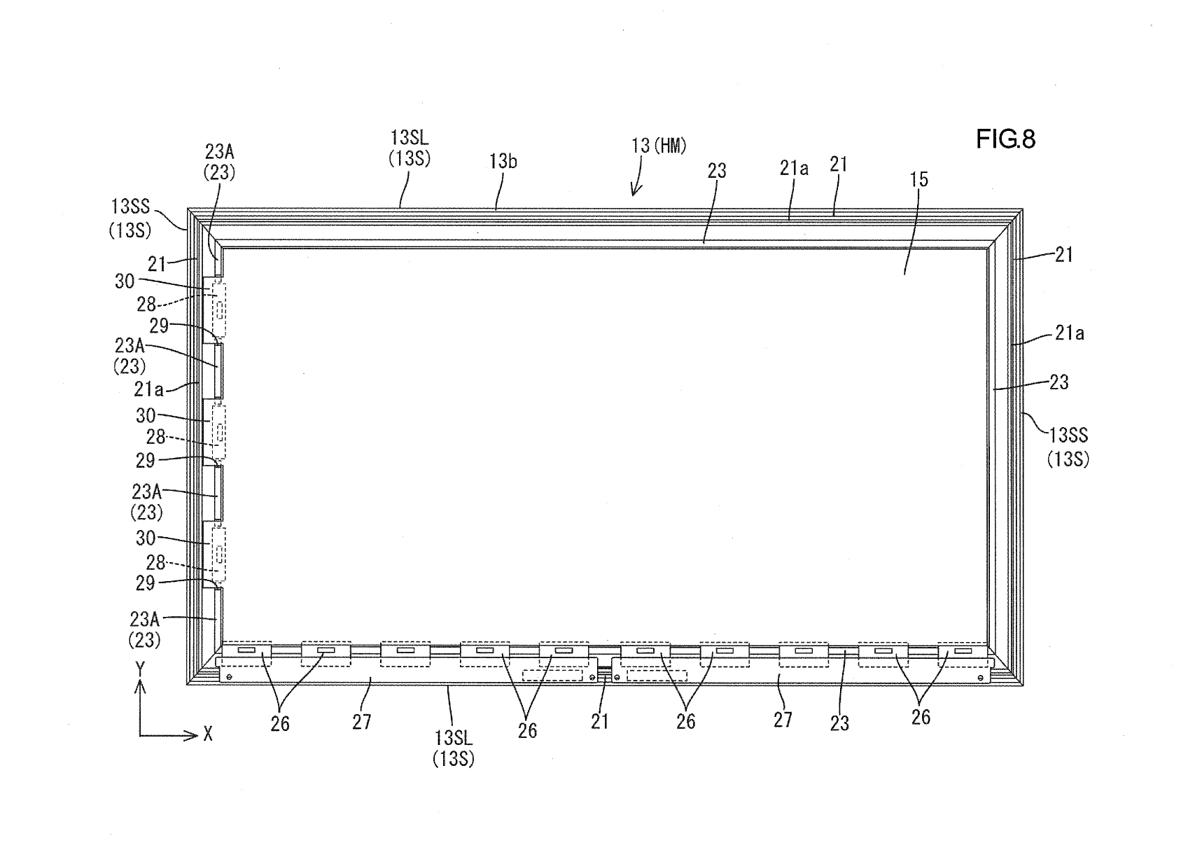

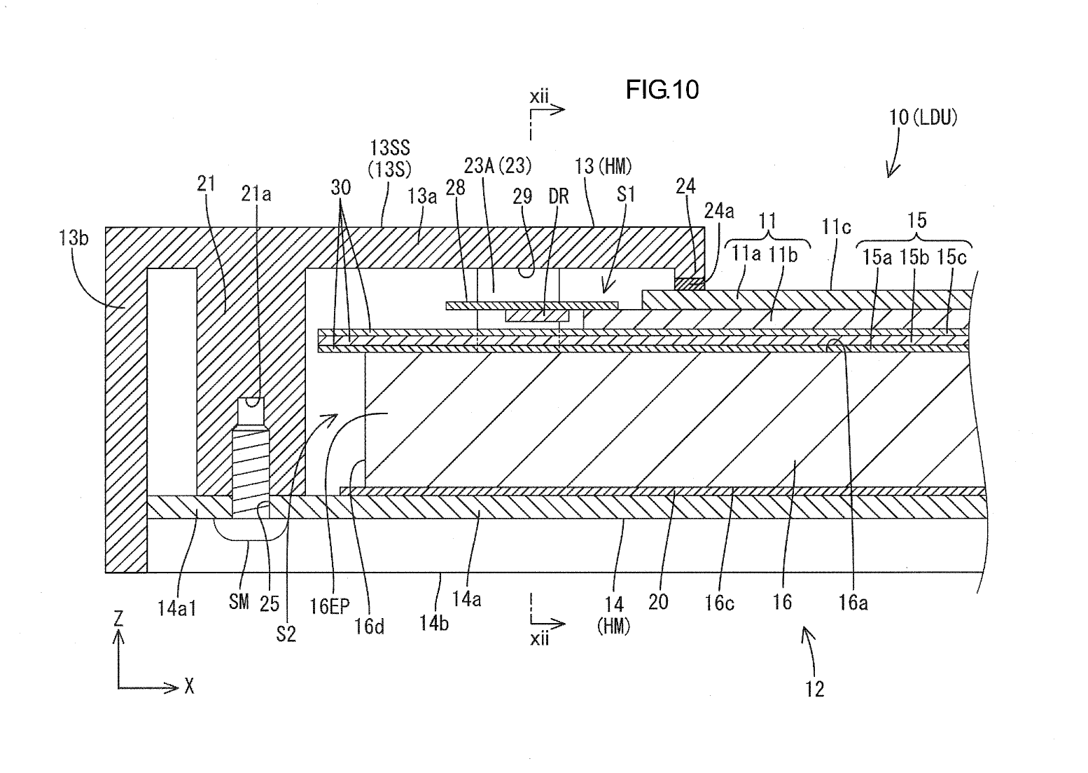

As illustrated in FIG. 8, the frame 13 formed in a frame-like shape with the above basic configuration includes four frame pieces 13S that are assembled together. Each frame piece 13S corresponds to each side portion of the frame 13 (long-side portions and shot-side portions). Specifically, the frame pieces 13S include long-side frame pieces 13SL and short-side frame pieces 13SS that constitute long-side portions and short-side portions of the frame 13 (the panel holding portions 13a and the sidewalls 13b), respectively. Each long-side frame piece 13SL is a rectangular block member that extends in the X-axis direction and has an L-like cross section. Each short-side frame piece 13SS is a rectangular block member that extends in the Y-axis direction and has an L-like cross section. In such a configuration, the frame pieces 13S can be formed by extruding metal material in the production process, for example, and thus the production cost can be reduced compared to a frame 13 formed by cutting a metal material. The long-side frame pieces 13SL and the short-side frame pieces 13SS that are adjacent to each other form the frame 13 by jointing the respective edges thereof in the respective extending directions. As illustrated in FIG. 8, the edges of the long-side frame pieces 13SL and the edges of the short-side frame pieces 13SS, which are the joint portions of the frame pieces 13SL and 13SS (joints in the frame 13), are angled against the X-axis and Y-axis directions in a plan view. Specifically, each edge extends along a line that connecting an inner edge and an outer edge of the corner portion in the panel holding portion 13a. The long-side frame pieces 13SL (refer to FIG. 6) cover not only the liquid crystal panel 11, the optical member 15, and the light guide plate 16 but also the LED units LU. On the other hand, the short-side frame pieces 13SS (see FIG. 10) do not cover the LED units LU. Therefore, the long-side frame piece 13SL has a relatively larger width than the short-side frame pieces 13SS.

As illustrated in FIGS. 4 and 5, each panel holding portion 13a includes the screw attachment portion (fixing member attachment portions) 21 at a more interior position with respect to the sidewall 13b of each panel holding portion 13a (a position away from the sidewall 13b toward the light guide plate 16). The screw member (the fixing member) SM is attached to the screw attachment portion 21. The screw attachment portions 21 each protrude from an inner surface of the corresponding panel holding portion 13a toward the rear side in the Z-axis direction and each have an elongated block-like shape that extends along a corresponding side of the panel holding portion 13a (in the X-axis direction and the Y-axis direction). The screw attachment portions 21 each extend on each side of the panel holding portion 13a with a length equal to the length of each side of the panel holding portion 13a. As illustrated in FIG. 8, the screw attachment portions 21 are each arranged on each frame piece 13S included in the frame 13. If the frame pieces 13S are connected with each other, the screw attachment portions 21 forma frame-like shape that continues over its entire periphery along inner surfaces of the sidewall 13b having a rectangular hollow shape. As illustrated in FIG. 4 and FIG. 5, each screw attachment portion 21 includes a groove 21a that opens to the rear side and to which the screw member SM can be fastened. The groove 21a extends in the longitudinal direction of the screw attachment portion 21 over substantially the entire length thereof. The groove 21a has a width that is slightly smaller than that of a shaft portion of the screw member SM. The screw attachment portion 21 is positioned between the panel holding portion 13a of the frame 13 and the chassis 14 in the Z-axis direction.

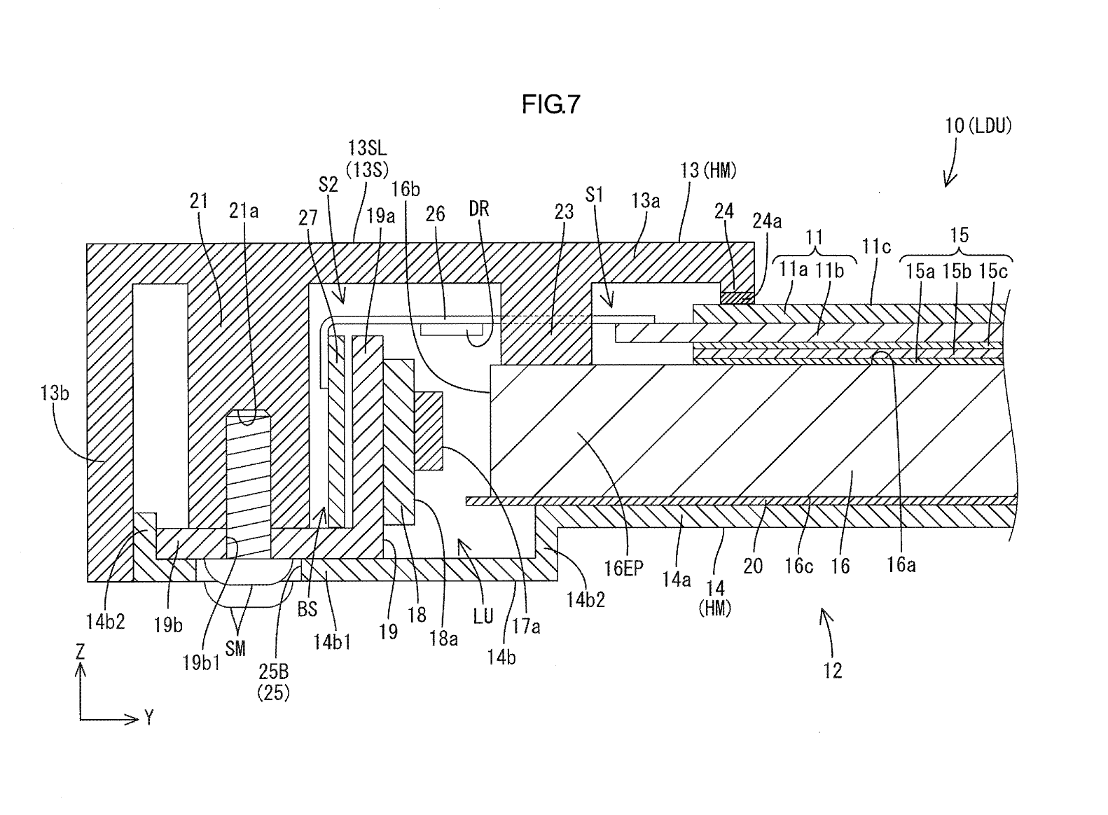

As illustrated in FIG. 4, the screw attachment portions 21 that extend along the long sides are each positioned between the sidewall 13b of the frame 13 and the LED attachment portion 19a of the heat dissipation member 19, which is included in the LED unit LU, in the Y-axis direction. The screw attachment portion 21 is away from the LED attachment portion 19a by a predetermined distance. As illustrated in FIGS. 6 and 7, a board space BS in which the printed circuit board 27 is arranged is provided between one of the heat dissipation members 19 that overlaps the source flexible board 26 in a plan view and the screw attachment portion 21, to which the heat dissipation member 19 is attached. In other words, the printed circuit board 27 is arranged between the screw attachment portion 21 and the LED attachment portion 19a. The printed circuit board 27 is made of synthetic resin and has an elongated plate-like shape that extends in the longitudinal direction of the screw attachment portion 21 and the LED attachment portion 19a (in the X-axis direction). The printed circuit board 27 is arranged in the board space BS such that a plate surface of the printed circuit board 27 extends parallel to an outer plate surface of the LED attachment portion 19a (a surface opposite to the LED board 18 side). In other words, the printed circuit board 27 is arranged in the board space BS such that the long-side direction, the short-side direction, and the thickness direction of the printed circuit board 18 correspond to the X-axis direction, the Z-axis direction, and the Y-axis direction, respectively. On the printed circuit board 27, multiple source flexible boards 26 are arranged away from each other in the long-side direction of the printed circuit board 27 and connected to the printed circuit board 27 at the other end thereof. The source flexible boards 26 that are connected to the printed circuit board 27 and the array board 11b of the liquid crystal panel 11 extend over the LED attachment portion 19a, the LED board 18, and the LEDs 17 in the Y-axis direction. The printed circuit board 27 includes a connecter (not illustrated) to which an end of an FPC (not illustrated) is connected. The other end of the FPC extends to the rear side of the chassis 14 through an FPC hole (not illustrated) in the chassis 14 and is connected to the control board CTB.

As illustrated in FIGS. 4 and 5, light blocking portions 23 are formed in one piece with the respective panel holding portions 13a. The light blocking portion 23 is located on an inner side with respect to the respective screw attachment portions 21. Each of the light blocking portions 23 is arranged to range between the panel holding portion 13a and the corresponding end portion 16EP of the light guide plate 16. The light blocking portion 23 defines a first space S1 between the light blocking portion 23 and the end portion of the liquid crystal panel 11 and a second space S2 between the light blocking portion 23 and the end surface (the light entrance surface 16d or the LED non-opposed surface 16d) of the end portion 16EP of the light guide plate 16. The light blocking portion 23 is located between the first space S1 and the second space S2 so that the spaces S1 and S2 are optically independent from each other. This blocks light travelling between the spaces S1 and S2. The liquid crystal display device 10 according to this embodiment includes the liquid crystal panel 11, the optical member 15, and the light guide plate 16 that are directly placed on the top of one another and does not include a panel receiving member arranged between the light guide plate and the liquid crystal panel as is included in the conventional configuration. Even with such a configuration of this embodiment, light in the second space S2 is less likely to enter the first space S1 and directly enter the end portion of the liquid crystal panel 11. The light blocking portions 23 each protrude from the inner surface of the panel holding portion 13a toward the rear side in the Z-axis direction (a protrusion direction of the screw attachment portion 21) and have an elongated block-like shape that extends along each side of the panel holding portion 13a. A length of each light blocking portion 23 that extends along the corresponding side of the panel holding portion 13a is equal to a length of the corresponding side of the panel holding portion 13a. As illustrated in FIG. 8, similar to the screw attachment portions 21, each of the frame pieces 13S of the frame 13 includes the light blocking portion 23. If the frame pieces 13S are connected to each other, the corresponding light blocking portions 23 form a frame-like shape that follows an entire length of the panel holding portion 13a (the light guide plate 16).

As illustrated in FIGS. 4 and 5, each of the light blocking portions 23 is arranged so as to overlap the corresponding end portion 16EP of the light guide plate 16 that protrudes to the outer side with respect to the liquid crystal panel 11, in a plan view (a view from the display surface 11c side). A protruded end surface of each light blocking portion 23 is in contact with a front surface of the corresponding end portion 16EP, i.e., the light exit surface 16a. The light blocking portions 23 sandwich the light guide plate 16 together with the chassis 14, which will be described later, and can support the light guide plate 16 from the front side (the display surface 11c side). Thus, the light blocking portions 23 have alight guide plate supporting function. The end portions 16EP of the light guide plate 16 are pressed by the light blocking portions 23 forming a frame-like shape from the front side over a substantially entire length of the end portions 16EP. The long-side end portions 16EP of the light guide plate 16 that are in contact with the light blocking portions 23 include the light entrance surfaces 16b that light from the LEDs 17 enters. With such a configuration, the light blocking portions 23 support the light guide plate 16, and this keeps a stable positional relation between the LEDs 17 and the light entrance surfaces 16b in the Z-axis direction.

Among the light blocking portions 23 in the frame-like shape as a whole, a pair of long-side light blocking portions 23 is included in the long-side frame piece 13SL and extends along the long side of the panel holding portion 13a. As illustrated in FIG. 4, each of the long-side light blocking portions 23 is arranged between the first space S1 which the end portion of the liquid crystal panel 11 faces and the second space S2 which the light entrance surface 16b of the light guide plate 16 and the LEDs 17 faces. Therefore, the light blocking portion 23 blocks light from the LEDs 17 from entering the end portion of the liquid crystal panel 11 directly without passing through the light guide plate 16. As illustrated in FIGS. 6 and 7, one of the long-side light blocking portions 23 that overlaps the source flexible boards 26 in a plan view includes source flexible board insertion recesses 23a. The source flexible board insertion recesses 23a are cutouts and formed at intervals along the X-axis direction corresponding to the source flexible boards 26.

As illustrated in FIGS. 4 and 5, the panel holding portion 13a integrally includes a holding protrusion 24 that protrudes from an inner edge of the panel holding portion 13a toward the rear side, i.e., toward the liquid crystal panel 11. The holding protrusion 24 includes a shock absorber 24a at its protruded end. The holding protrusion 24 can press the liquid crystal panel 11 from the front-surface side with the shock absorber in-between. As illustrated in FIG. 8, similar to the screw attachment portion 21, each of the frame pieces 13S that constitute the frame 13 includes the holding protrusion 24 and the shock absorber 24a, and the holding protrusions 24 and the shock absorbers 24a extend along the respective sides of the frame 13. When the frame pieces 13S are assembled together, the holding protrusions 24 and the shock absorbers 24a forma frame-like shape along inner edge portions of the panel holding portions 13a as a whole.

As illustrated in FIG. 3, the chassis 14 has a substantially longitudinal shallow tray shape as a whole and covers overall areas of the light guide plate 16 and the LED units LU from the rear side. A rear outer surface of the chassis 14 (a surface opposite from a surface that faces the light guide plate 16 and the LED units LU) is seen from the rear side and constitutes a back surface of the liquid crystal display device 10. The chassis 14 includes a bottom plate portion 14a and LED housings (light source housings) 14b. The bottom plate portion 14a has a landscape rectangular shape similar to the light guide plate 16. Each LED housing 14b protrudes from long-side ends of the bottom plate portion 14a toward the rear side in a step-like shape and houses the LED units LU.

As illustrated in FIGS. 3 and 4, the bottom plate portion 14a has a plane plate shape so as to receive a middle area of the light guide plate 16 in the short-side direction (except the end portions in the short-side direction) from the rear side. The bottom plate portion 14a will be referred to as a light guide plate receiving portion. As illustrated in FIG. 5, end portions of the bottom plate portion 14a in the long-side direction extend to an outer side with respect to the end portions of the light guide plate 16 in the long-side direction. The end portions of the bottom plate portion 14a in the long-side direction are screw mount portions (fixing member attachment portions) 14a1 to which the screw members (fixing members) SM are attached from the outside. The screwed members SM hold the frame 13 and the chassis 14 in a fixed condition.

As illustrated in FIGS. 3 and 4, the LED housings 14b are located so as to sandwich the bottom plate portion 14a therebetween in the short-side direction. Each LED housing 14b is recessed from the bottom plate portion 14a toward the rear side to have a space in which the LED units LU can be arranged. Each LED housing 14b includes a screw mount portion (a fixing member attachment portion) 14b1 and side plates 14b2. The screw mount portion 14b1 is parallel to the bottom plate portion 14a and the screw members SM are attached thereto from the outside. The side plates 14b2 rise from ends of the screw mount portion 14b1 toward the front side. One of the side plates 14b2 on the inner side continues to the bottom plate portion 14a. The inner surface of the screw mount portion 14b1 of the LED housing 14b is in contact with the heat dissipation portion 19b of the heat dissipation member 19 included in the LED unit LU. Another one of the side plates 14b2 of the LED housing 14b on the outer side is arranged in a space provided between the screw attachment portion 21 and the side wall 13b on the long side. The side plate 14b2 on the outer side has a positioning function with which the chassis 14 is properly positioned with respect to the frame 13 in the Y-axis direction.

As illustrated in FIG. 3, the screw mount portions 14b1 of the LED housings 14b are located on the long-side end portions of an outer peripheral portion of the chassis 14. The screw mount portions 14a1 of the bottom plate portion 14a are located on the short-side end portions of the outer peripheral portion of the chassis 14. The screw mount portions 14a1 of the bottom plate portion 14a and the screw mount portions 14b1 of the LED housings 14b include screw holes 25 through which the screw members SM are passed. The screw mount portions 14a1 and 14b1 overlap the screw attachment portions 21 of the frame 13 in a plan view. The screw holes 25 formed in the screw mount portions 14a1 and 14b1 are communicated with the grooves 21a of the screw attachment portions 21. With this configuration, the screw members SM are passed through the screw holes 25 in the Z-axis direction (the overlapping direction of the liquid crystal panel 11, the optical member 15, and the light guide plate 16) from the rear side of the chassis 14 (the side opposite to the display surface 11c side). The screw members SM are fastened to the grooves 21a of the screw attachment portions 21 with the screw mount portions 14a1 and 14b1 therebetween. When the screw member SM is fastened, the groove 21a is threaded by a thread of the shaft portion of the screw member SM. The screw holes 25 of the screw mount portions 14b1 that are formed in the LED housings 14b include common screw holes 25A and heat dissipation member screw holes 25B. As illustrated in FIG. 6, only the shaft portion of the screw member SM passes through the common screw hole 25A. The screw member SM that is passed through the common screw hole 25A fixes the heat dissipation portion 19b and the housing bottom plate portion 14b1 to the screw attachment portion 21. As illustrated in FIG. 7, a head portion of the screw member SM in addition to the shaft portion of the screw member SM passes through the heat dissipation member screw hole 25B. The screw member SM that is passed through the heat dissipation member screw hole 25B fixes only the heat dissipation portion 19b to the screw attachment portion 21.

As illustrated in FIGS. 5 and 8, the gate flexible boards 28 described earlier are connected to one of the short-side end portions of the outer peripheral portions of the liquid crystal panel 11 so as to protrude therefrom to the outer side. The gate flexible boards 28 overlap the short-side end portion 16EP of the light guide plate 16 in a plan view. On the other hand, the light blocking portions 23 have the substantially frame-like shape as a whole and extend from the panel holding portion 13a to the respective end portions 16EP of the light guide plate 16 and hold the respective end portions 16EP from the front side. The light blocking portions 23 are arranged to overlap the respective end portions 16EP substantially over the entire end portions of the light guide plate 16 when seen from the front side (the display surface 11c side). The light blocking portions 23 are necessary to be configured such that one of the light blocking portions 23 corresponding to the end portion 16EP that overlaps the gate flexible boards 28 in a plan view, that is, a short-side light blocking portion 23A on the left in FIGS. 5 and 8 does not contact the gate flexible boards 28. Hereinafter, one of the light blocking portions 23 on the gate flexible boards 28 side will be represented by 23A. The light blocking portion may be arranged on an outer side with respect to the gate flexible boards 28 so as not to contact each other. However, in such a configuration, a frame portion of the liquid crystal display device may increase in size and the liquid crystal display device may not keep a small frame portion. If the liquid crystal display device may be configured not to increase a size of the frame portion, a sufficient width of a light blocking portion may not be ensured and may not obtain mechanical strength that is necessary for supporting the light guide plate 16.

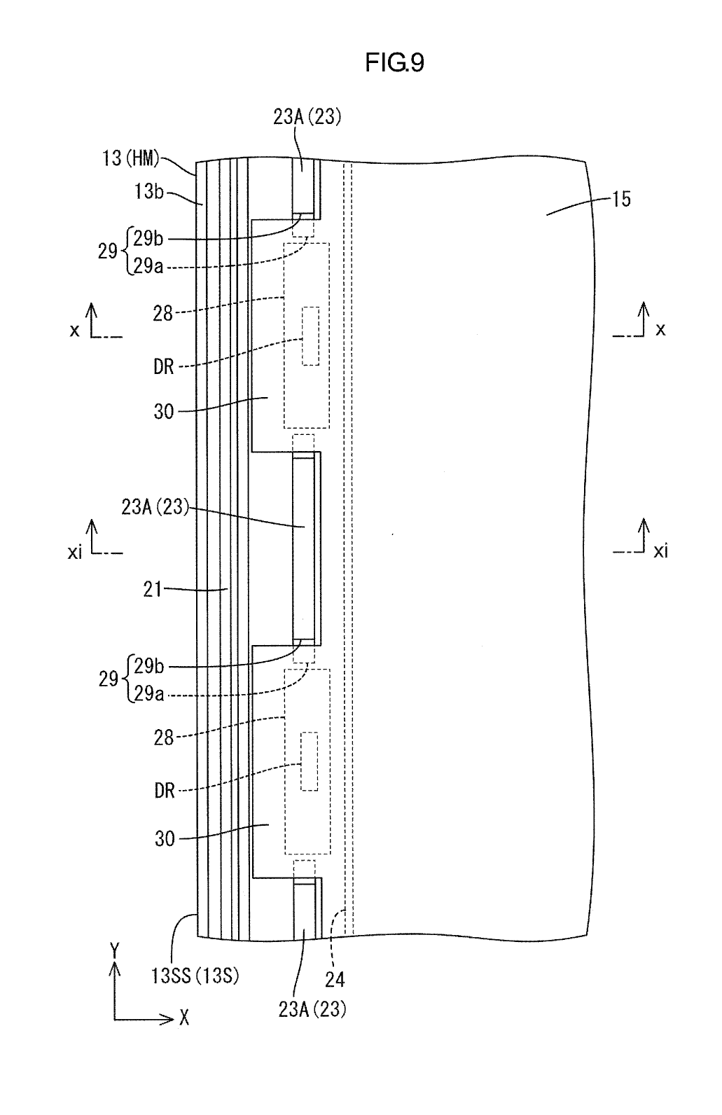

In this embodiment, as illustrated in FIGS. 9 to 11, the light blocking portion 23A that overlaps the gate flexible boards 28 seen from the front side includes gate flexible board insertion recesses 29 through which the respective gate flexible boards 28 pass. Further, the optical member 15 includes light restriction portions 30 with which light is less likely to pass through the gate flexible board insertion recesses 29. Specifically, the light blocking portion 23A that includes the gate flexible board insertion recesses 29 does not come in contact with the gate flexible boards 28. Further, the light blocking portion 23A is aligned with the gate flexible boards 28 along the short-side end portion (Y-axis direction) of the liquid crystal panel 11 to which the gate flexible boards 28 are connected. Therefore, the light blocking portion 23A is formed in a space that is obtained by a protrusion dimension of the gate flexible boards 28 protruding from the short-side end portion of the liquid crystal panel 11. With such a configuration, sufficient mechanical strength of the light blocking portion 23A can be obtained, and the light guide plate 16 can be supported stably while the size of the frame of the liquid crystal display device 10 remains small. The gate flexible boards 28 are passed through the respective gate flexible board insertion recesses 29 and accordingly, outer end portions (protruded end portions protruding from the end portion of the liquid crystal panel 11) of the gate flexible boards 28 are located on an outer side with respect to the light blocking portion 23A. The gate flexible boards 28 pass through the light blocking portion 23A in a width direction of the light blocking portion 23A.

As illustrated in FIG. 10, the gate flexible board insertion recess 29 formed in the light blocking portion 23A communicates the first space S1 with the second space S2. The end portion of the liquid crystal panel 11 is located in the first space S1. The LED non-opposed surface 16d of the end portion 16EP of the light guide plate 16 that overlaps the gate flexible boards 28 seen from the front side faces the second space S2. With such a configuration, light from the end portion 16EP through the LED non-opposed surface 16d leaks into the second space S2 and the light may enter the first space S1 through the gate flexible board insertion recess 29. The light may directly enter a part of the end portion of the liquid crystal panel 11 to which the gate flexible boards 28 are connected. The optical member 15 according to this embodiment includes the light restriction portions 30 that are arranged in the respective gate flexible board insertion recesses 29. Therefore, light in the second space S2 that is on the outer side with respect to the light blocking portion 23A is less likely to pass through the gate flexible board insertion recess 29 and is less likely to directly enter the part of the end portion of the liquid crystal panel 11 to which the gate flexible board 28 is connected and that is located in the first space S1. The light restriction portions 30 can compensate a light blocking function of the light blocking portions 23A. Therefore, light is less likely to leak toward the end portions of the liquid crystal panel 11 and thus the display quality of the displayed images can be maintained at a high level. Hereinafter, configurations of the light restriction portions 30 and the gate flexible board insertion recesses 29 will be described in detail.

As illustrated in FIGS. 8 and 9, the light restriction portions 30 protrude from one of the short-side end portions among outer peripheral end portions of the optical member 15 to the outer side similar to the gate flexible boards 28. Specifically, the light restriction portions 30 protrude to an outer wide with respect to from an end portion of the optical member 15 that overlaps the gate flexible boards 28 when seen from the front side so as to be formed in a cantilever shape and is formed into one piece with the optical member 15. Arrangement of the light restriction portions 30 in a plan view is the same as that of the gate flexible boards 28 and the gate flexible board insertion recesses 29 of the light blocking portion 23A. Specifically, three light restriction portions 30 are arranged away from one another along the short-side end portion (Y-axis direction) of the optical member 15. Each of the three sheets of the optical member 15 (the diffuser sheet 15a, the lens sheet 15b, and the reflection type polarizing sheet 15c) includes the light restriction portion 30 and the light restriction portion 30 include three light restriction sheet portions having substantially the same size (a plan shape).

As illustrated in FIG. 10, outer end portions (protruded end portions protruding from the end of the optical member 15) of the light restriction portions 30 are located on outer sides with respect to outer ends of the gate flexible boards 28 and the light blocking portions 23A in the X-axis direction. Further, the outer end portions of the light restriction portions 30 are located on an outer side with respect to the LED non-opposed surface 16d of the short-side end portion 16EP of the light guide plate 16 in the X-axis direction so as to protrude therefrom. The outer ends of the light restriction portions 30 reach a position close to an inner side surface of the screw portion 21 facing the inner side. In this configuration, light leaking from the light guide plate 16 through the LED non-opposed surface 16d is less likely to enter a front-side area of the second space S2 that is on the front side with respect to the light restriction portions (the optical member 15). Therefore, light is effectively restricted from entering the gate flexible board insertion recesses 29. As illustrated in FIG. 9, a width of each light restriction portion 30, i.e., a size of each light restriction portion 30 in a direction along the short-side end of the liquid crystal display panel 11 to which the gate flexible boards 28 are connected (Y-axis direction), is larger than that of each gate flexible board 28. Accordingly, the light restriction portion 30 has a size larger than that of the gate flexible board 28 in the X-axis direction and the Y-axis direction when seen from the front side. An entire area of the gate flexible board 28 is covered with the light restriction portion 30 from the rear side. Therefore, light leaking out through the LED non-opposed surface 16d from the light guide plate 16 that is on the rear side of the light restriction portion 30 is less likely to enter the gate flexible boards 28, and thus the light is effectively restricted from entering the end portion of the liquid crystal panel 11 to which the gate flexible boards 28 are connected.

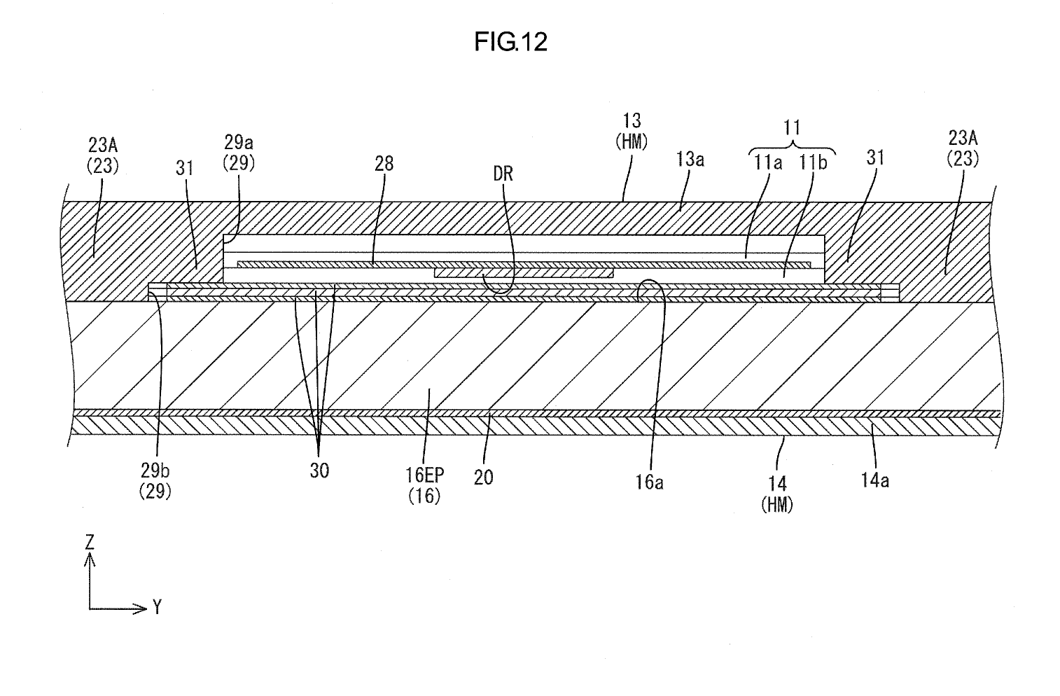

As illustrated in FIG. 12, the gate flexible board insertion recess 29 penetrates through the light blocking portion 23A in its width direction (X-axis direction) so that the first space S1 and the second space S2 communicate with each other. The gate flexible board insertion recess 29 is open to the rear side, i.e. the light guide plate 16 side. The gate flexible board insertion recess 29 has two different widths and includes a first insertion recess 29a and a second insertion recess 29b. The first insertion recess 29a through which the gate flexible board 28 passes has a relatively smaller size. The second insertion recess 29b through which the light restriction portion 30 passes has a size relatively larger than the first insertion recess 29a. Specifically, the first insertion recess 29a has a size in the Y-axis direction that is larger than that of the gate flexible board 28 but smaller than that of the light restriction portion 30. Therefore, only the gate flexible board 28 can pass through the first insertion recess 29a. Namely, the first insertion recess 29a has a minimal size that allows the gate flexible board 28 to pass. With this configuration, light is less likely to enter the first insertion recess 29a. The second insertion recess 29b has a size in the Y-axis direction that is larger than the light restriction portion 30 so that the light restriction portion 30 can pass therethrough. The light restriction portion 30 that is inserted through the second insertion recess 29b faces the gate flexible board 28 that is inserted through the first insertion recess 29a with being away from each other in the Z-axis direction. Recessed edge portions of each second insertion recess 29b are in contact with a front surface (facing the gate flexible board 28 side) of the light restriction portion 30. In other words, the gate flexible board insertion recess 29 includes contact portions 31 that project from recess edges of each gate flexible board insertion recess 29 toward the rear side (the light guide plate 16 side). Projected end surfaces of the contact portions 31 are in contact with the front surface of the light restriction portion 30. The light restriction portion 30 is sandwiched between the contact portions 31 (the recess edge portions of the second insertion recess 29b) and the light guide plate 16. With this configuration, a gap between the light restriction portion 30 and the contact portions 31 (the recessed edges of the second insertion recess 29b) and a gap between the light restriction portion 30 and the light guide plate 16 are less likely to be formed, and thus light leakage is surely restricted.

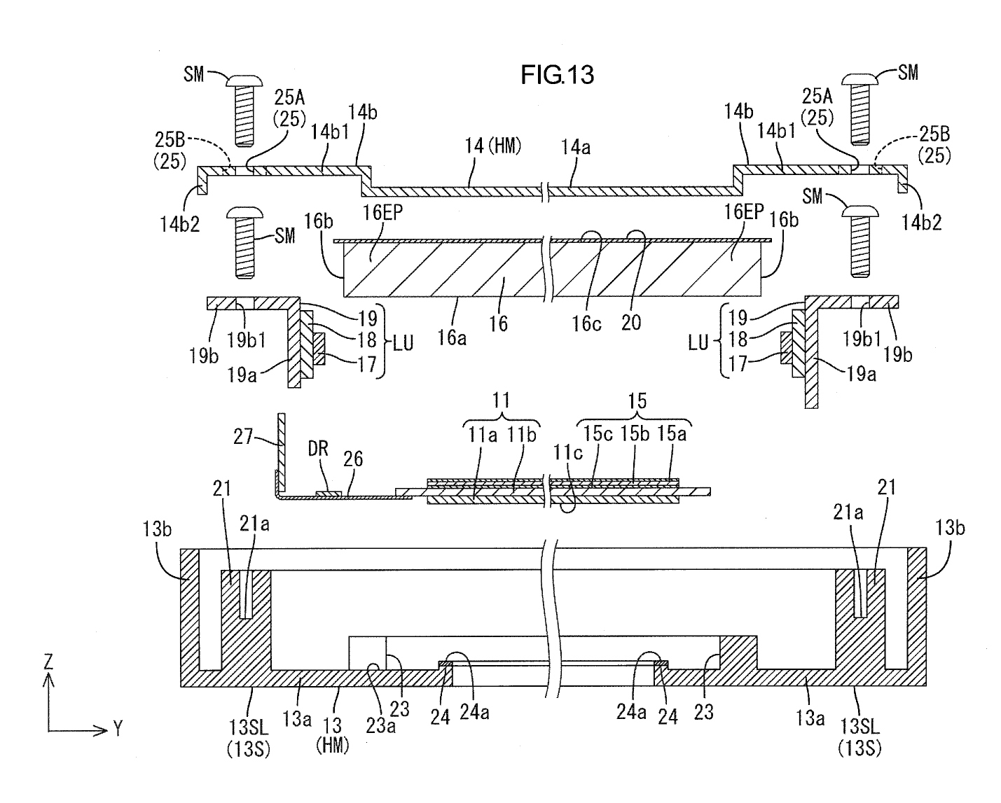

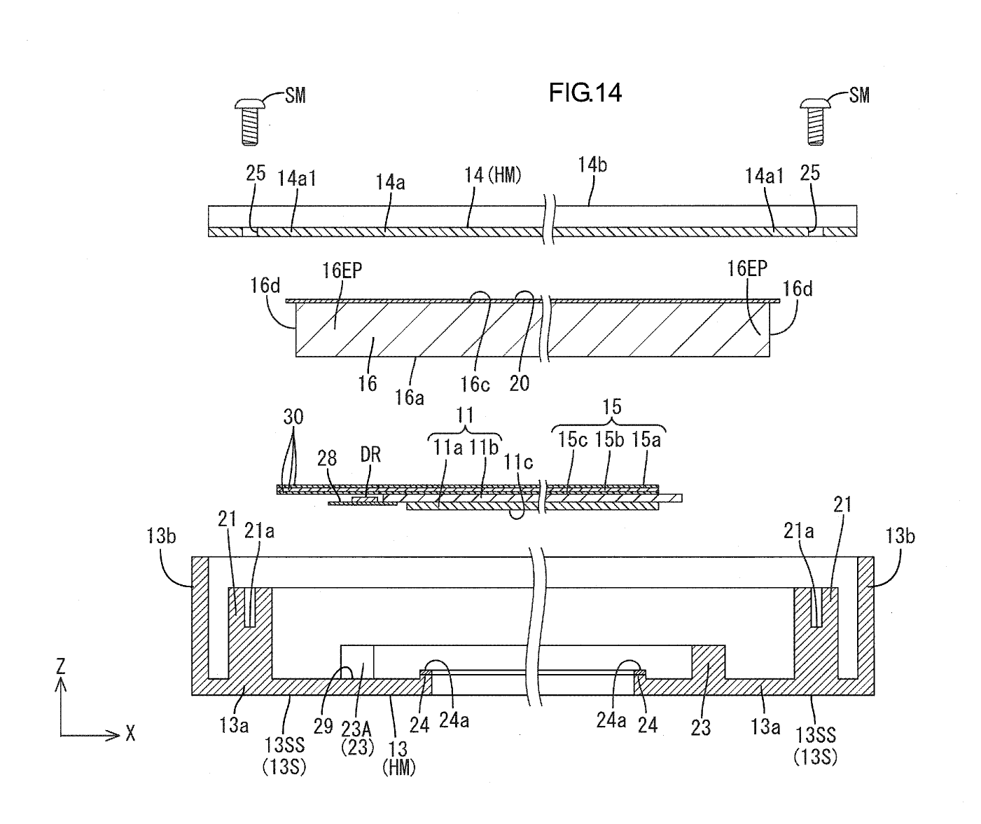

The present embodiment has the above-described structure, and an operation thereof will be described. The components (e.g. the frame 13, the chassis 14, the liquid crystal panel 11, the optical member 15, the light guide plate 16, and the LED units LU) are separately produced and assembled into the liquid crystal display device 10. All of the components are assembled with a state in which the upsides of FIGS. 4 and 5 are turned down in the Z-axis direction. As illustrated in FIGS. 13 and 14, the frame 13 is placed on a workbench (not illustrated) with the rear surface thereof facing the upside in the vertical direction. The frame 13 is formed into a frame shape in advance by jointing the four frame pieces 13S together.

As illustrated in FIGS. 13 and 14, the source flexible boards 26 and the printed circuit boards 27 are connected to one of the long-side end portions of the liquid crystal panel 11, and the gate flexible board 28 is connected to one of the short-side end portions of the liquid crystal panel 11 in advance. The liquid crystal panel 11 is attached to the frame 13 that is placed as described earlier such that the CF substrate 11a is located on a lower side in the vertical direction and the array substrate 11b is located on an upper side. As illustrated in FIG. 13, the printed circuit board 27 is attached to the screw attachment portion 21 such that the plate surface of the printed circuit board 27 is parallel to a surface of the long-side screw attachment portion 21 of the frame 13 that faces the liquid crystal panel 11 side. The source flexible board 26 is bent into an L-like shape. In this attachment process, the source flexible board 26 is fitted into the source flexible board insertion recess 23a with being positioned in the X-axis direction with respect to the source flexible board insertion recess 23a of the light blocking portion 23 that overlaps the source flexible board 26 in a plan view. As illustrated in FIG. 14, the gate flexible board 28 is fitted into the first insertion recess 29a of the gate flexible insertion recess 29 with being positioned in the Y-axis direction with respect to the first insertion recess 29a of the gate flexible board insertion recess 29 included in the short-side light blocking portion 23A that overlaps the gate flexible board 28 in a plan view. The liquid crystal panel 11 is placed on the shock absorber 24a attached on the holding protrusion 24 of the frame 13 so that shocks are absorbed by the shock absorber 24a.

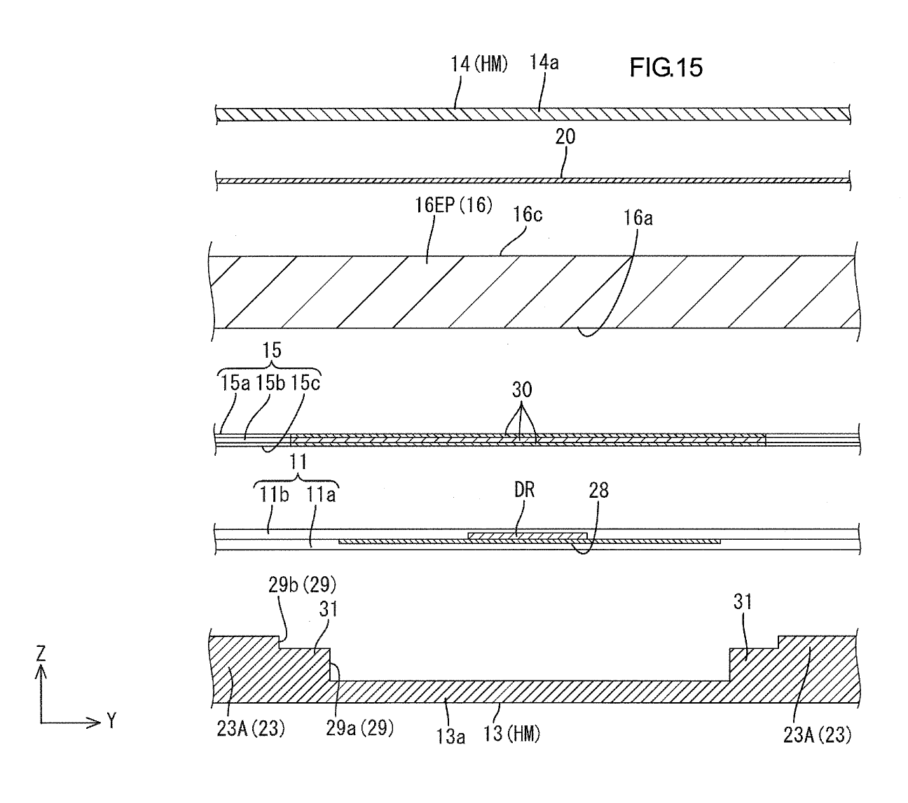

Next, the optical sheets of the optical member 15 are sequentially placed on the rear side surface of the liquid crystal panel 11. As illustrated in FIGS. 14 and 15, the light restriction portions 30 located on one of the short-side end of the optical member 15 are fitted to the respective gate flexible board insertion recesses 29 formed in the blocking portion 23A of the frame 13 with being positioned in the Y-axis direction. The light restriction portions 30 are fitted to the respective second insertion recesses 29b that have relatively larger width in the gate flexible board insertion recess 29. The outer end portion of the light restriction portion 30 is located on the outer side with respect to the outer end of the corresponding gate flexible board 28 and the outer end of the corresponding light blocking portion 23A in the X-axis direction. The entire area of the gate flexible board 28 is covered with the light restriction portion 30 from the rear side.

As illustrated in FIG. 13, the LED units LU each including the LEDs 17, the LED board 18, and the heat dissipation member 19 that are assembled together in advance are mounted to the frame 13. Each LED unit LU is placed on each screw attachment portion 21 on the long side of the frame 13 such that the LEDs 17 face the middle (inner side) of the frame 13 and the heat dissipation portion 19b of each heat dissipation member 19 faces the screw attachment portion 21 of the frame 16. When the LED units LU are attached to the respective screw attachment portions 21, each of the through holes 19b1 of the heat dissipation portion 19b communicates with the recess 21a of each screw attachment portion 21. The LED unit LU that overlaps the source flexible boards 26 in a plan view defines the board space BS between the LED attachment portion 19a and the screw attachment portion 21 when the heat dissipation member 19 is attached to the screw attachment portion 21. The printed circuit board 27 is arranged in the board space BS. After the attachment of the LED units LU to the screw attachment portions 21, the screw members SM are passed through the predetermined through holes 19b1 of the heat dissipation portions 19b from the rear side and fastened to the recesses 21a of the screw attachment portions 21. The heat dissipation portions 19b of the heat dissipation members 19 are sandwiched between the head portions of the screw members SM and the screw attachment portions 21, and thus the LED units LU are fixed to the screw attachment portions 21 in advance of the mounting operation of the chassis 14, which will be described later (see FIG. 7). The LED units LU may be mounted to the frame 13 before the mounting operation of the optical member 15 or the liquid crystal panel 11 to the frame 13.

After the LED units LU are screwed to the screw attachment portions 21, as illustrated in FIGS. 13 and 14, the light guide plate 16 is directly placed on the rear surface of one of the optical sheets of the optical member 15 that is arranged on the rearmost side. The end portions 16EP of the light guide plate 16, which protrudes to the outer side with respect to the respective end portions of the liquid crystal panel 11, are supported by the light blocking portions 23 of the frame 13 from the front side, i.e., the lower side in the vertical direction during the assembly. The light blocking portions 23 have the substantially frame-like shape as a whole corresponding to an outer shape of the light guide plate 16 and support the end portions 16EP of the light guide plate 16 substantially over its entire length. As illustrated in FIGS. 14 and 15, one of the end portions 16EP of the light guide plate 16 that overlaps the gate flexible boards 28 is arranged so as to sandwich the light restriction portion 30 together with the contact portions 31 (the recess edges of the second insertion recess 29b) of the gate flexible board insertion recess 29. With this configuration, a gap is less likely to be generated between the light guide plate 16, the light restriction portions 30, and the contact portions 31. After the light guide plate 16 is mounted, the light guide reflection sheet 20 is directly placed on the plate surface 16c that is opposite to the light exit surface 16a of the light guide plate 16.

After the liquid crystal panel 11, the optical member 15, the light guide plate 16, and the LED units LU are mounted to the frame 13 as described earlier, the mounting operation of the chassis 14 is performed. As illustrated in FIGS. 13 and 14, the chassis 14 is mounted to the frame 13 with the front surface thereof face-down in the vertical direction. The side plate 14b2 on the outer side of each LED housing 14b of the chassis 14 is inserted in each space provided between the sidewall 13b on the long side and the screw attachment portion 21 in the frame 13. Accordingly, the chassis 14 is positioned in the Y-axis direction with respect to the frame 13. In the mounting operation, the head portions of the screw members SM that are attached to the heat dissipation members 19 and the screw attachment portions 21 in advance pass through the heat dissipation member screw holes 25B of the LED housings 14b of the chassis 14 (see FIG. 7). Then, the bottom plate portion 14a of the chassis 14 comes into contact with the light guide plate 16 (the light guide reflection sheet 20), the screw mount portions 14a1 of bottom plate portion 14a come into contact with the screw attachment portions 21, and LED mount portion 14b1 of the LED housing 14b comes into contact with the heat dissipation member 19. Subsequently, the screw members SM are inserted into the screw holes 25 of LED mount portions 14a1 of the bottom plate portion 14a and the common screw holes 25A of the LED mount portions 14b1 of the LED housings 14b from the rear side. The screw members SM are then fastened in the groove 21a of the screw attachment portion 21. The LED units LU and the chassis 14 are fixed to the screw attachment portions 21 by the screw members SM (see FIG. 6). In this configuration, the screw members SM are arranged on the rear side of the chassis 14 that provides the rear external configuration of the liquid crystal display device 10. Therefore, the screw members SM are less likely to be recognized from the front side, that is, the user of the liquid crystal display device 10 is less likely to see the screw members SM directly. The liquid crystal display device 10 can have an improved design with a simplified appearance.

The mounting operation of the liquid crystal display unit LDU is complete as described above. After the stand attachments STA and the boards PWB, MB, and CTB are mounted to the rear side of the liquid crystal display unit LDU, the stand ST and the cover CV are attached to the liquid crystal display unit LDU. Thus, the liquid crystal display device 10 and the television device TV are produced. The external configuration of the liquid crystal display device 10 produced as above is provided by the frame 13 that holds the liquid crystal panel 11 from the display surface 11c side and the chassis 14 that constitutes the backlight unit 12. Further, the liquid crystal panel 11 and the optical member 15 are placed on top of one another directly. In some conventional liquid crystal display devices, a cabinet that is made of synthetic resin may be provided as a different part from the frame 13 and the chassis 14 or a panel receiving member may be arranged between the liquid crystal panel 11 and the optical member 15 such that the liquid crystal panel 11 and the optical member 15 are not in contact with each other. Compared to such a configuration, the production cost can be reduced because the numbers of components and assembly steps are reduced. Furthermore, the thickness and weight of the liquid crystal display device 10 can be reduced.

As illustrated in FIG. 4, when the liquid crystal display device 10 produced as above is turned on and the power is supplied from the power source board PWB, signals are sent from the control board CTB to the liquid crystal panel 11 via the printed circuit board 27 and the flexible boards 26 and 28 (drivers DR) and operation of the liquid crystal panel 11 is controlled. Furthermore, the LEDs 17 included in the backlight unit 12 are driven. Light from each LED 17 is guided by the light guide plate 16 toward the optical member 15. The light passes through the optical member 15 and exits the optical member 15 as a planar light having an even brightness. The planar light reaches the liquid crystal panel 11. The liquid crystal panel 11 displays images using the planar light. Hereinafter, operations of the backlight unit 12 will be described in detail. As illustrated in FIG. 6, when the LED 17 is turned on, light emitted by the LED 17 enters the light guide plate 16 through the light entrance surface 16b. The light in the light guide plate 16 may be totally reflected at an interface of the light guide plate 16 with an outer air layer, or reflected by the light guide reflection sheet 20. The light travels throughout the light guide plate 16. The light is reflected and scattered by reflection portions or scattering portions, which are not illustrated, of the light guide plate 16 and exits the light guide plate 16 from the light exit surface 16a toward the optical member 15.

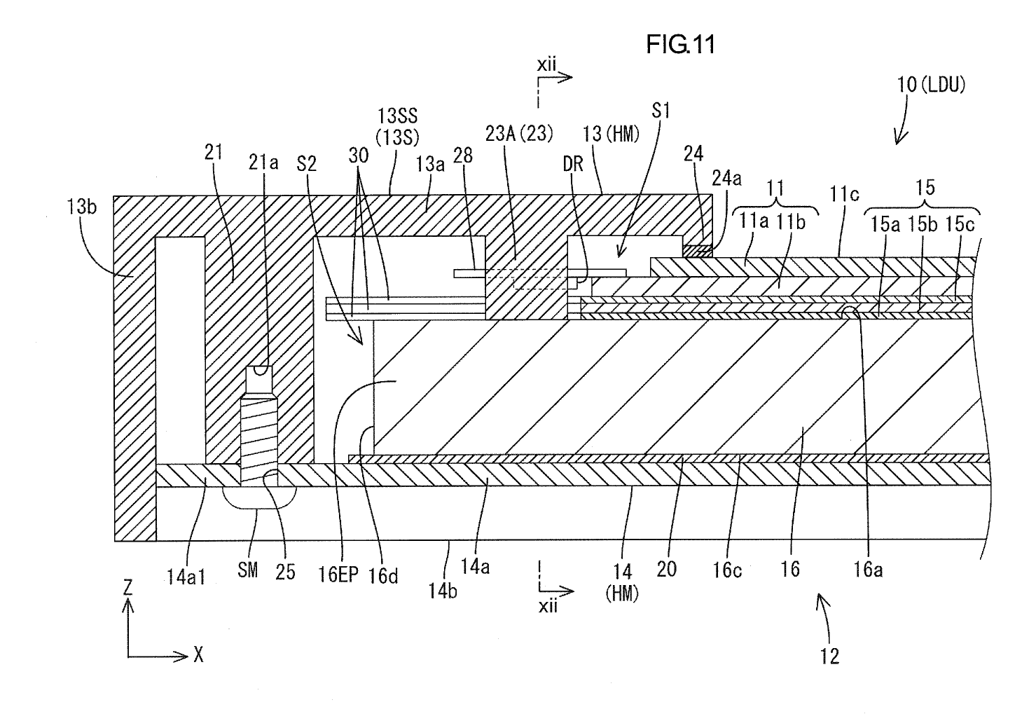

In the liquid crystal display device 10 according to this embodiment, the liquid crystal panel 11 is directly placed on the light guide plate 16 and the optical member 15, and a panel receiving member is not arranged unlike the conventional configuration. Therefore, light may leak to the end portions of the liquid crystal panel 11. In this embodiment, as illustrated in FIGS. 7 and 11, since the light blocking portion 23 extends from the panel holding portion 13a of the frame 13 to the end portion 16EP of the light guide plate 16, light in the second space S2 where the end portions 16EP of the light guide plate 16 face is less likely to enter the space S1 where the end of the liquid crystal panel 11 faces, and the light is less likely to directly enter the end portion of the liquid crystal panel 11.

However, among the light blocking portions 23 that form the frame-like shape, the light blocking portions 23A that overlap the respective gate flexible boards 28 in a plan view include the gate flexible board insertion recesses 29 through which the respective gate flexible boards 28 pass. Therefore, light in the second space S2 is more likely to enter the first space S1 through the gate flexible board insertion recess 29 in the part of the end portion of the liquid crystal panel 11 to which the gate flexile board 28 is connected. In this embodiment, as illustrated in FIGS. 9 and 10, the optical member 15 includes the light restriction portions 30 each of which is arranged in the corresponding gate flexible board insertion recess 29. The light restriction portions 30 can absorb or reflect light leaking from the end portion 16EP of the light guide plate 16 through the non-LED opposed surface 16d to the second space S2. Therefore, light is less likely to pass through the gate flexible board insertion recesses 29 and accordingly an amount of light that passes therethrough can be reduced. With this configuration, light in the second space S2 that is on the outer side with respect to the light blocking portion 23A is less likely to enter the first space S1 that is on an inner side with respect to the light blocking portion 23A through the gate flexible board insertion recesses 29. Thus, the light is less likely to leak and directly enter the part of the end portion of the liquid crystal panel 11 to which each gate flexible board 28 is connected.

As illustrated in FIGS. 9 and 10, the outer ends of the light restriction portions 30 are located on the outer side with respect to the outer end of the respective gate flexible boards 28 in the X-axis direction, and the light restriction portions 30 each have a size larger than that of the gate flexible board 28 in the Y-axis direction. Namely, the light restriction portions 30 each have the size larger than that of each gate flexible board 28 when seen from the front side. Therefore, light in the second space S2 is less likely to enter the gate flexible boards 28, and light is effectively restricted from directly entering the part of the end portion of the liquid crystal panel 11 to which each gate flexible board 28 is connected. Further, the outer ends of the light restriction portions 30 are each arranged on the outer side with respect to the outer end of the respective light blocking portions 23A and the LED non-opposed surface 16d of the light guide plate 16. Therefore, light leaking through the LED non-opposed surface 16d to the second space S2 is further less likely to travel through the gate flexible board insertion recesses 29, and thus light is more effectively restricted from entering the end portion of the liquid crystal panel 11. Furthermore, the gate flexible board insertion recesses 29 each have two different widths and the light restriction portion 30 is sandwiched between the contact portions 31 located on the recess edge portions of each gate flexible board insertion recess 29 and the end portion 16EP of the light guide plate 16. Therefore, a light restriction property of the light restriction portions 30 can be further ensured, and thus the light leakage to the end portion of the liquid crystal panel 11 is suitably reduced.

As described earlier, the liquid crystal display device (the display device) 10 includes the LEDs (the light sources) 17, the liquid crystal panel (the display panel) 11, the gate flexible boards (the panel connecting members) 28, the light guide plate 16, the optical member 15, a holding member HM including the frame 13 and the chassis 14 as a pair of holding members, the light blocking portion 23A, and a light restriction portion 30. The liquid crystal panel 11 is configured to provide a display using light from the LEDs 17. The gate flexible boards 28 are connected to the end portion of the liquid crystal panel 11 and protrude from the end of the liquid crystal panel 11 to the outer side. The light guide plate 16 is arranged so as to overlap the side opposite to the display surface 11c side of the liquid crystal panel 11. The light entrance surface 16b, i.e. the end surface of the light guide plate 16 is arranged opposite the LEDs 17. The optical member 15 is arranged between the liquid crystal panel 11 and the light guide plate 16. The holding member HM including the pair of holding portions, that is, the frame 13 and the chassis 14, houses the LEDs 17 and the gate flexible boards 28 and holds the liquid crystal panel 11, the optical member 15, and the light guide plate 16 from the display surface 11c side from the side opposite to the display surface 11c side. The light blocking portion 23A is arranged between the frame 13, which is one of the holding portions arranged on the display surface 11c side, and the light guide plate 16. The light blocking portion 23A is configured to block light on the outer side with respect to the light blocking portion 23A from directly entering the end of the liquid crystal panel 11. The light blocking portion 23A includes the gate flexible board insertion recesses (the insertion recesses) 29 through which the respective gate flexible boards 28 pass. The light restriction portions 30 are provided to the optical member 15 and arranged in the respective gate flexible board insertion recesses 29. The light restriction portions 30 are configured to restrict light on the outer side with respect to the light blocking portion 23A from directly entering the end of the liquid crystal panel 11 through the flexible board insertion recesses 29.

In this configuration, light emitted from the LEDs 17 enters the light guide plate 16 through the light entrance surface 16b, which is the end surface of the light guide plate 16, and the light travels toward the liquid crystal panel 11 through the optical member 15. While passing through the optical member 15, the light receives predetermined optical effects. The liquid crystal panel 11 displays an image using the light. The liquid crystal panel 11, the optical member 15, and the light guide plate 16 that are arranged to overlap one another are sandwiched by the frame 13 and the chassis 14, i.e. the pair of the holding portions included in the holding member HM from the display surface 11c side and the side opposite to the display surface 11c side. Unlike the conventional display device, a panel receiving member is not arranged between the light guide plate 16 and the optical member 15 and the liquid crystal panel 11. Therefore, light may leak to the end portion of the liquid crystal panel 11. However, as described earlier, the light blocking portion 23A is arranged to range between the frame 13, which is one of the pair of holding portions (the frame 13 and the chassis 14) arranged on the display surface 11c side, and the light guide plate 16. Thus, the light blocking portion 23A can block at least light that is located on the outer side with respect to the light blocking portion 23A from directly entering the end portion of the liquid crystal panel 11.

The light blocking portion 23A includes the gate flexible board insertion recess 29 through which the gate flexible board 28 that protrudes outward from the end of the liquid crystal panel 11 passes. Therefore, light outside the light blocking portion 23A may pass through the gate flexible board insertion recess 29 and directly enter the part of the end portion of the liquid crystal panel 11 to which the gate flexible board 28 is connected. However, as described above, the optical member 15 includes the light restriction portion 30 that is arranged in the corresponding gate flexible insertion recess 29. The light restriction portion 30 can restrict the light outside the light blocking portion 23A from passing through the gate flexible insertion recess 29 and directly entering the part of the end portion of the liquid crystal panel 11 to which the gate flexible board 28 is connected. A light blocking function of the light blocking portion 23A is compensated by the light restriction portion 30 and thus light leakage to the end portion of the liquid crystal panel 11 can be appropriately reduced. This improves display quality of the image displayed in the liquid crystal panel 11.

The light restriction portions 30 each have the range larger than that of each gate flexible board 28 in the direction along the end of the liquid crystal panel 11. With this configuration, since the light restriction portion 30 has the size larger than that of the gate flexible board 28 in the direction along the end of the liquid crystal panel 11, the light on the outer side with respect to the light blocking portion 23A is less likely to enter the gate flexible board 28 that is arranged in the gate flexible insertion recess 29. Therefore, the light is less likely to enter the part of the end portion of the liquid crystal panel 11 to which the gate flexible board 28 is connected.

The gate flexible board insertion recesses 29 each include the first insertion recess 29a through which the gate flexible board 28 passes and the second insertion recess 29b through which the light restriction portion 30 passes. The second insertion recess 29b has the range larger than that of the first insertion recess 29a. The second insertion recess 29b includes the contact portions 31 that are the recess edge portions. The contact portions 31 are in contact with the surface of the light restriction portion 30 on the gate flexible board 28 side. With this configuration, the first insertion recess 29a can be provided with a minimum range within which the gate flexible board 28 can pass through the first insertion recess 29a. Therefore, a light blocking area provided by the light blocking portion 23A can be maximized and a light blocking property can be further enhanced. Further, because the contact portions 31 that are the recess edge portions included in the second insertion recess 29b, through which the light restriction portion 30 passes, are in contact with the surface of the light restriction portion 30 on the gate flexible board 28 side, gaps are less likely to occur between the light restriction portion 30 and the contact portions 31 (the recess edge portions of the second insertion recess 29b). Thus, a light restriction property of the light restriction portion 30 is further enhanced.

The light restriction portions 30 are held between the contact portions 31, that is, the recess edge portions of the second insertion recesses 29b, and the light guide plate 16. With this configuration, gaps are less likely to be generated not only between the light restriction portion 30 and the contact portions 31, that is, the recess edge portions of the second insertion recess 29b, but also between the light restriction portion 30 and the light guide plate 16. Thus, the light restriction property of the light restriction portion 30 is further enhanced.

The outer ends of the light restriction portions 30 are located on the outer side with respect to the protruded distal ends of the gate flexible boards 28. With this configuration, the outer ends of light restriction portions 30 that are arranged on the outer side with respect to the protruded ends of the gate flexible boards 28 can suitably restrict the light that is on the outer side with respect to the light blocking portion 23A from entering the gate flexible board 28 in the gate flexible board insertion recess 29. Thus, light is less likely to enter the part of the end portion of the liquid crystal panel 11 to which the flexible board 28 is connected.

The outer ends of the light restriction portions 30 are located on the outer side with respect to the outer end of the light blocking portion 23A. With this configuration, light on the outer side of the light blocking portion 23A is suitably restricted from entering the gate flexible board insertion recess 29 by the light restriction portion 30 whose outer end is located on the outer side of the outer end of the light blocking portion 23A. Therefore, light is restricted from entering the part of the end portion of the liquid crystal panel 11 to which the flexible board 28 is connected.

The outer ends of the restriction portions 30 are located on the outer side with respect to the end surface of the light guide plate 16, that is, the LED non-opposed end surface 16d of the light guide plate 16. With this configuration, the light restriction portions 30 are located on the outer side of the LED non-opposed end surface 16d that is the end surface of the light guide plate 16, and if light leaks out through the LED non-opposed end surface 16d, the light restriction portions 30 suitably restrict the light from entering the gate flexible board insertion recesses 29. Therefore, light is further effectively restricted from entering the part of the end portion of the liquid crystal panel 11 to which the flexible board 28 is connected.

The light restriction portion 30 has the larger area than the gate flexible board 28 in a view from the display surface 11c side. With this configuration, the light restriction portion 30 having the larger area than the gate flexible board 28 suitably restricts light located on the outer side with respect to the light blocking portion 23A from entering the gate flexible board 28 that passes through the gate flexible board insertion recess 29. Therefore, light is further effectively restricted from entering the part of the end portion of the liquid crystal panel 11 to which the flexible board 28 is connected.

The light blocking portion 23A protrudes from the frame 13, which is one of the holding portions (the frame 13 and the chassis 14) arranged on the display surface 11c side, toward the light guide plate 16 and the protruded end surface thereof is in contact with the light guide plate 16. With this configuration, the protruded end surface of the light blocking portion 23A protruding from the frame 13, that is the one of the holding members arranged on the display surface 11c side, toward the light guide plate 16 is in contact with the light guide plate 16, and this supports the light guide plate 16 from the display surface 11c side. The light blocking portion 23A includes the gate flexible board insertion recess 29 through which the gate flexible board 28 pass, and the light blocking portion 23A and the gate flexible boards 28 are aligned in the direction along the end portion of the liquid crystal panel 11. Therefore, a space where the light blocking portion 23A is formed can be determined by the protrusion dimension with which the gate flexible board 28 protrudes from the end of the liquid crystal panel 11. With such a configuration, sufficient mechanical strength of the light blocking portion 23A is ensured, and the light guide plate 16 can be stably held with keeping a small frame width of the display device.

A plurality of the optical members 15 are placed on one another and each of the optical members 15 includes the light restriction portion 30. In this configuration, each light restriction portion 30 included in each optical member 15 is arranged in the gate flexible board insertion recess 29. Therefore, an improved light restriction property is ensured.

The light restriction portion 30 is integrally included in the optical member 15 as a part thereof. With this configuration, the optical member 15 can be easily produced compared to a case in which the light restriction portions 30 and the optical member 15 are separate parts. This enhances productivity.

The light restriction portion 30 protrudes from the end of the optical member 15 to the outer side in a cantilever shape. With this configuration, during the mounting operation of the optical member 15, the optical member 15 is mounted by inserting the light restriction portion 30 through the corresponding gate flexible board insertion recess 29 from the inner side. This improves workability.

### Second Embodiment

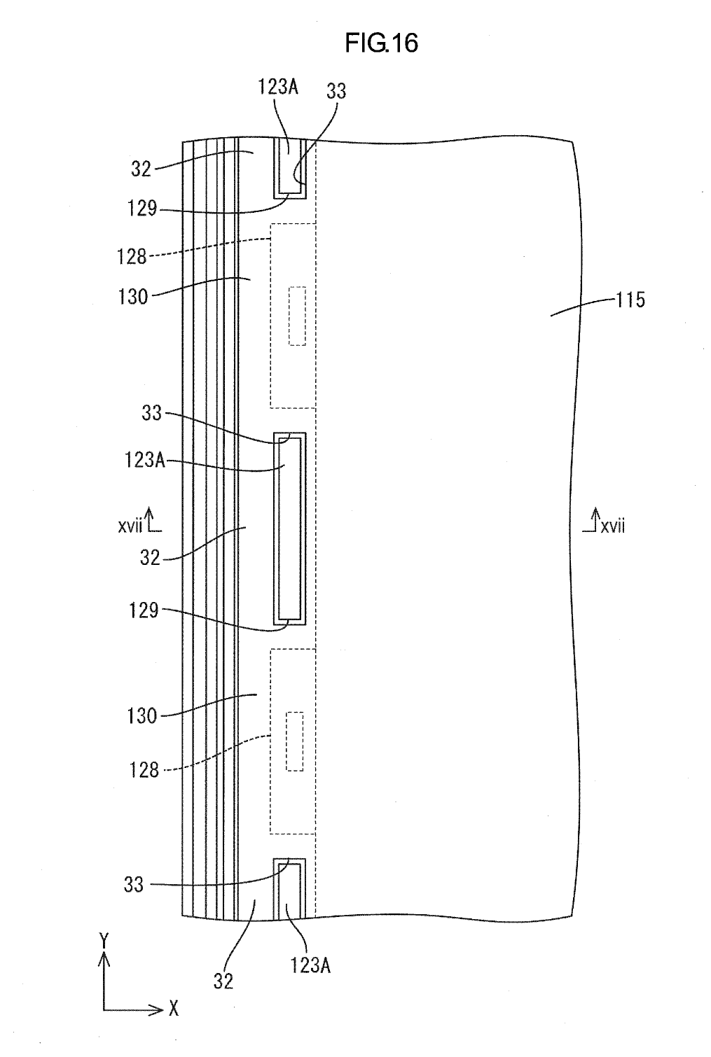

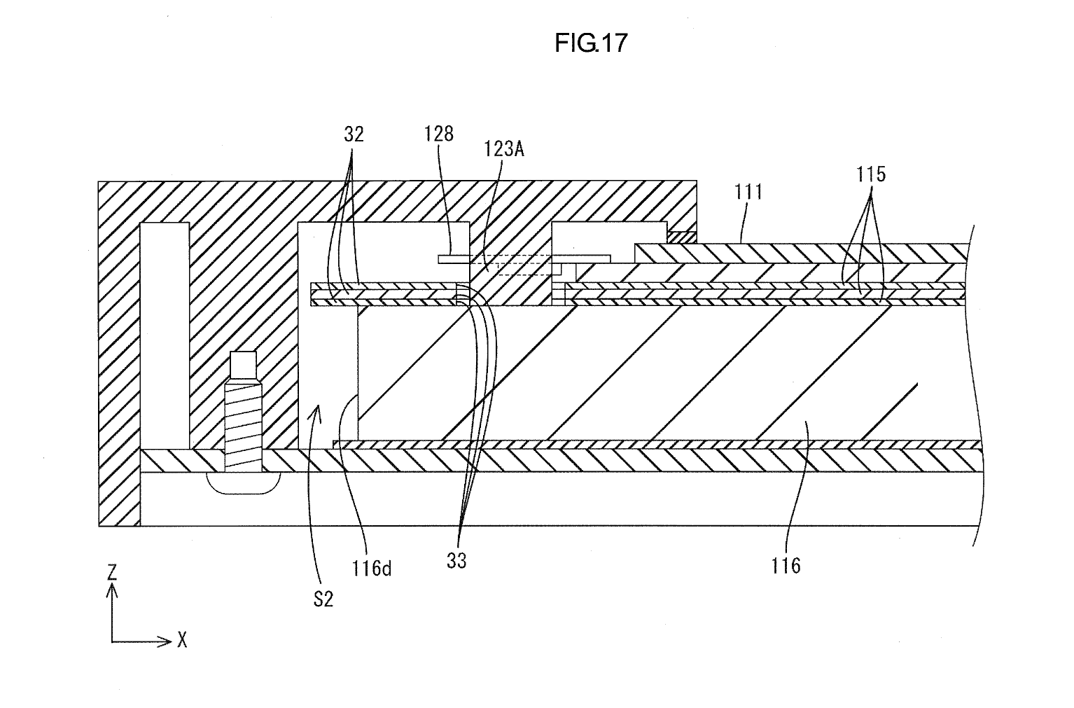

A second embodiment according to this invention will be described with reference to FIGS. 16 and 17. In the second embodiment, light restriction portions 130 that are adjacent to each other are connected by a connect portion 32. The same structures, operations, and effects as those of the first embodiment will not be described.

As illustrated in FIGS. 16 and 17, similar to the gate flexible boards 128 and gate flexible board insertion recesses 129, the light restriction portions 130 according to this embodiment are arranged apart from each other in the Y-axis direction. However, in this embodiment, the light restriction portions 130 that are adjacent to each other are connected by the connect portion 32. Therefore, the light restriction portions 130 are reinforced and less likely to be damaged even if the light restriction portions 130 hit other components during assembly. The connect portions 32 and the light restriction portions 130 are formed in one piece with optical member 115 including optical sheets. The connect portions 32 are located on an outer side with respect to light blocking portions 123A in the X-axis direction and continuously formed from respective protruded distal end portions of the light restriction portions 130 that protrude from the optical member 115. In other words, the optical member 115 according to this embodiment extends such that an end portion thereof on the gate flexible boards 128 side overlaps the gate flexible boards 128 and the light blocking portions 123A when seen from the front side. Further, openings 33 are formed in overlapping areas of the optical member 115 that overlap the respective light blocking portions 123A. The light blocking portions 123A pass through the respective openings 33. Outer ends of the light restriction portions 130 and the connect portions 32 are located on the outer side with respect to an LED non-opposed end surface 116d of a light guide plate 116 in the X-axis direction. Therefore, light leaking to the second space S2 through the LED non-opposed end surface 116d is less likely to enter a space on a front side with respect to the light restriction portions 130 and the connect portions 32. Thus, light restriction property is further improved.

As described above, according to this embodiment, the gate flexible boards 128, the light restriction portions 130, and the gate flexible board insertion recesses 129 are arranged at intervals along an end of a liquid crystal panel 111. Further, the connect portions 32 that connect the adjacent light restriction portions 130 are provided on the outer side with respect to the light blocking portions 123A. With such a configuration, since the adjacent light restriction portions 130 are connected by the connect portions 32, the light restriction portions 130 are less likely to be damaged, and thus the light restriction property is more reliably ensured.

### Third Embodiment

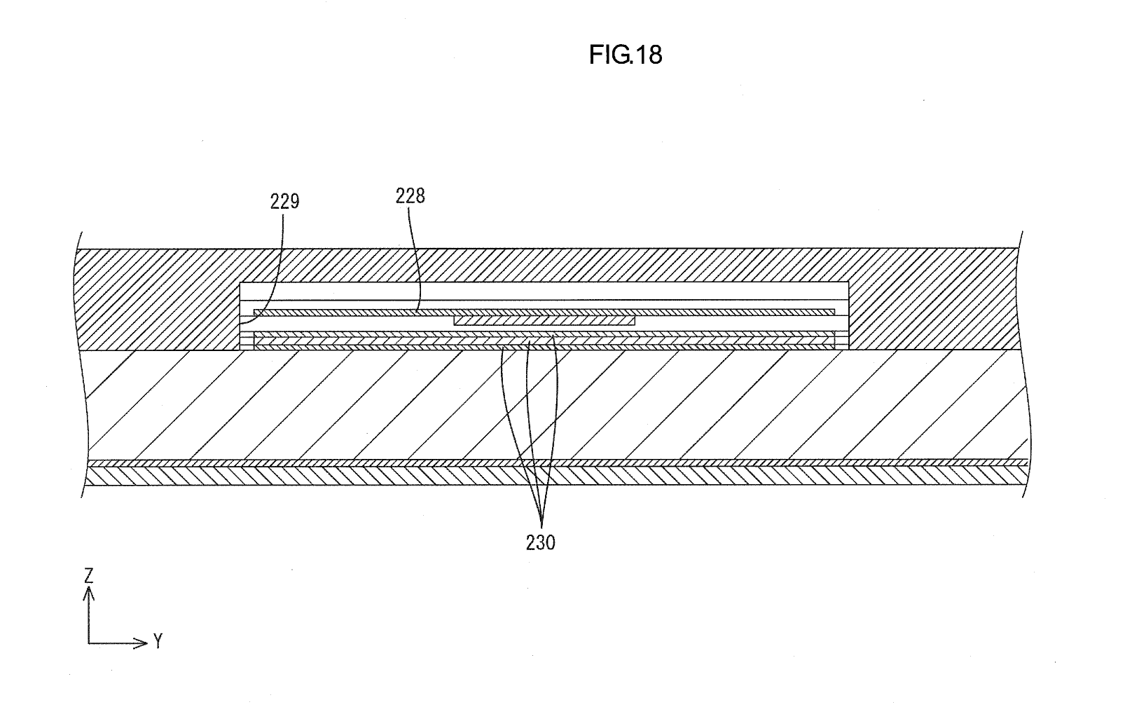

A third embodiment according to this invention will be described with reference to FIG. 18. In the third embodiment, a size of light restriction portion 230 is changed, and accordingly, a structure of a gate flexible board insertion recess 229 is changed. The same structures, operations, and effects as those of the first embodiment will not be described.

As illustrated in FIG. 18, the light restriction portion 230 according to this embodiment has a size in the Y-axis direction that is substantially the same as that of agate flexible board 228. The gate flexible board insertion recess 229 has a size in the Y-axis direction that is slightly larger than those of the gate flexible board 228 and the light restriction portion 230. A size of the gate flexible board insertion recess 229 in the Z-axis direction is constant over its entire area. Therefore, the gate flexible board insertion recess 229 in this embodiment does not include the contact portions 31 described in the first embodiment (refer to FIG. 12).

### Fourth Embodiment

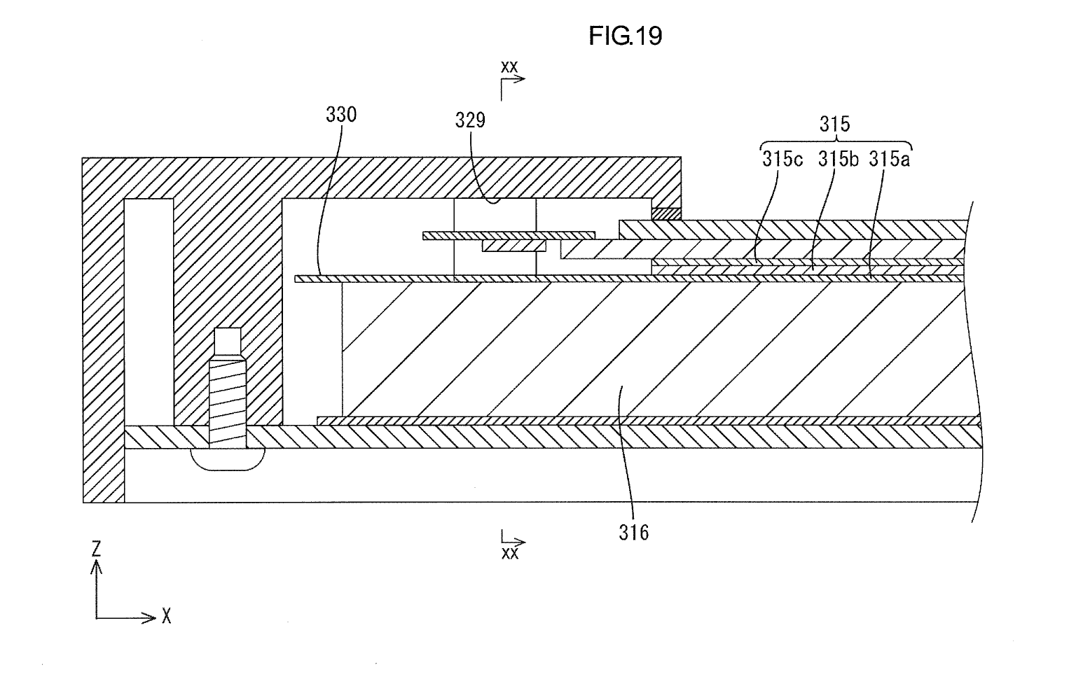

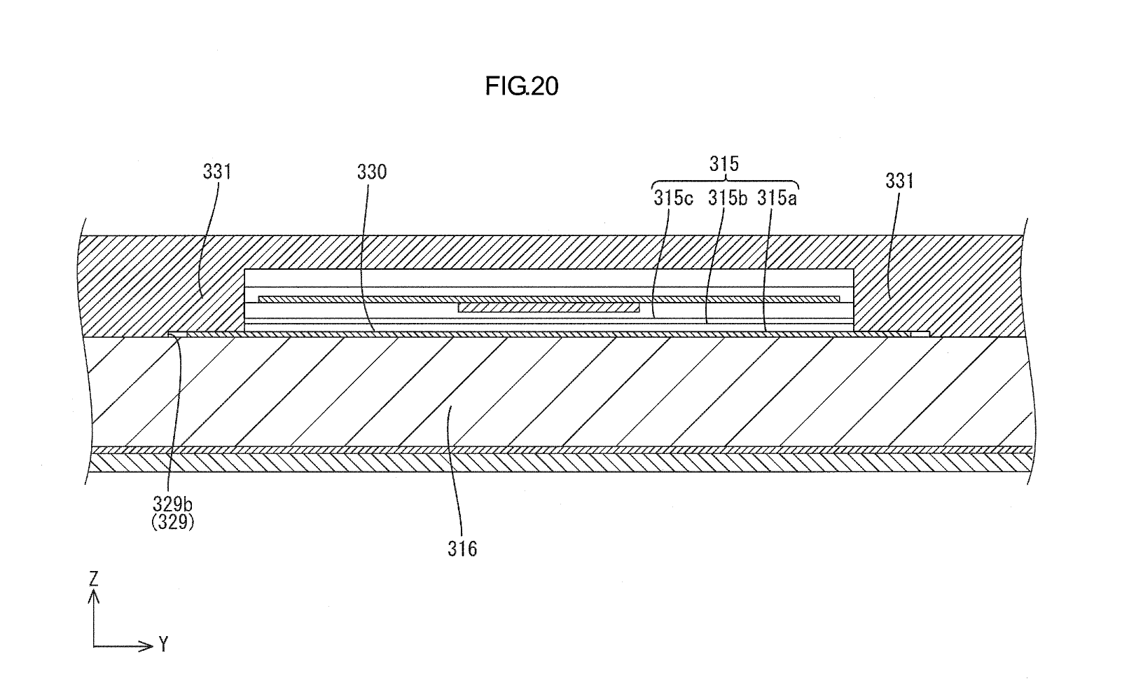

A fourth embodiment according to this invention will be described with reference to FIGS. 19 and 20. In the fourth embodiment, light restriction portions 330 are included in apart of optical member 315 including multiple sheets. The same structures, operations, and effects as those of the first embodiment will not be described.

As illustrated in FIGS. 19 and 20, only a diffuser sheet 315a that is on a rearmost side of overlaid three sheets of the optical member 315 includes the light restriction portions 330 according to this embodiment. A lens sheet 315b and a reflection type polarizing sheet 315c do not include the light restriction portions 330. Even in such a configuration, the light restriction portions 330 can suitably restrict light from entering the gate flexible board insertion recesses 329. Each second insertion recess 329b included in each gate flexible board insertion recess 329 has a size in the Z-axis direction that allows only one light restriction portion 330 of the diffuser sheet 315a to be arranged. A sheet of the light restriction portion 330 included in the diffuser sheet 315a is sandwiched between contact portions 331 that are recess edges of each second insertion recess 329b and a light guide plate 316.

### Fifth Embodiment

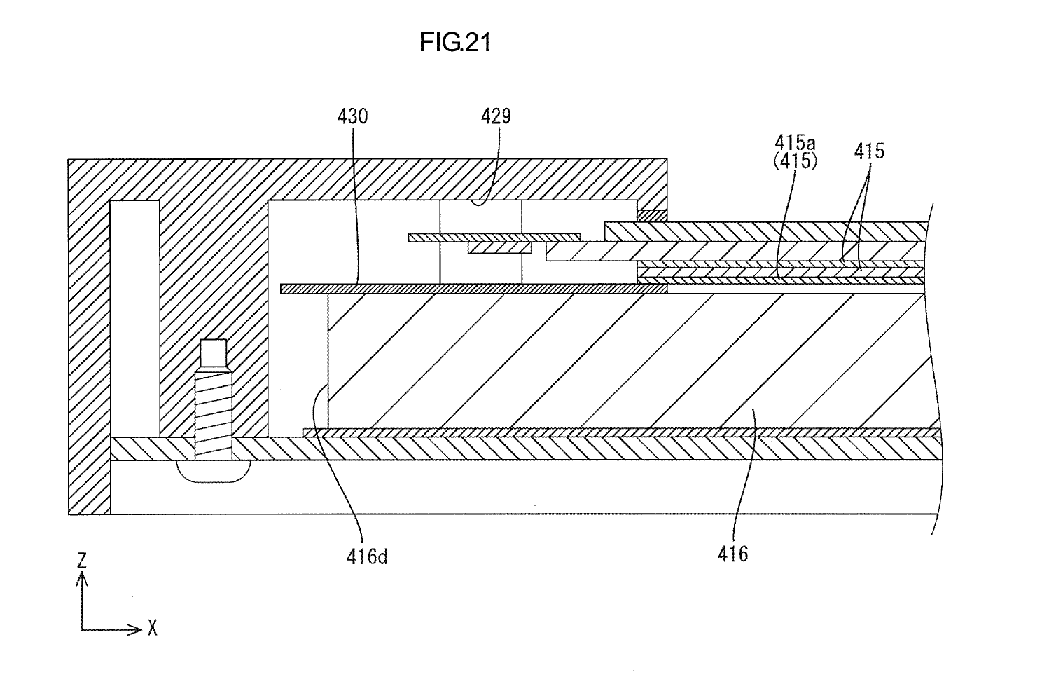

A fifth embodiment according to this invention will be described with reference to FIG. 21. In the fifth embodiment, light restriction portions 430 and an optical member 415 are different components. The same structures, operations, and effects as those of the first embodiment will not be described.

As illustrated in FIG. 21, the light restriction portions 430 according to this embodiment are different components from the optical member 415 and attached to the optical member 415 to be as one piece. Each light restriction portion 430 has a sheet-like shape having a size so as to pass through a corresponding gate flexible board insertion recess 429 and such that an outer end of each light restriction portion 430 is located on the outer side with respect to an LED non-opposed end surface 416d of a light guide plate 416. The light restriction portions 430 are attached to a short-side end portion of a diffuser sheet 415a that is on a rearmost side of the three sheets of the optical member 415 with a fixing material such as adhesive. The light restriction portions 430 are attached on a rear surface of the diffuser sheet 415a and arranged between the diffuser sheet 415a and the light guide plate 416 in the Z-axis direction. The light restriction portions 430 have a light blocking property so as to suitably absorb or reflect light leaking out through the LED non-opposed end surface 416d of the light guide plate 416. Therefore, the light restriction portions 430 can block light from entering the gate flexible board insertion recesses 429. The light restriction portions 430 may be formed by applying or printing a light blocking material on a surface of a light transmissive sheet, or formed of a sheet made of a light blocking material.

### Sixth Embodiment

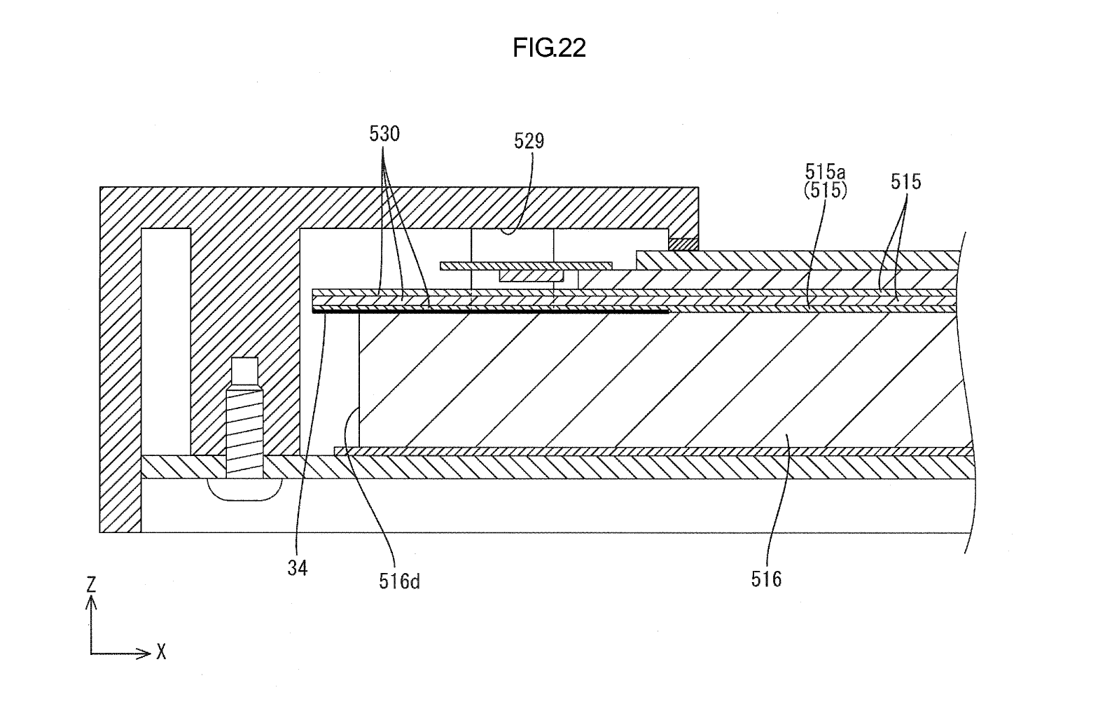

A sixth embodiment according to this invention will be described with reference to FIG. 22. In the sixth embodiment, light restriction portions 530 have a light blocking function. The same structures, operations, and effects as those of the first embodiment will not be described.

As illustrated in FIG. 22, a planar light blocking portion 34 is provided to the light restriction portion 530 according to this embodiment. The planar light blocking portion 34 is formed by applying or printing a light blocking material on a rear surface of the light restriction portion 530 that is one of the light restriction sheets included in a diffuser sheet 515a arranged on a rearmost side of the three sheets of the optical member 515. Namely, the light blocking material is provided on a surface of the light restriction portion 530 that faces a light guide plate 516. The planar light blocking portion 34 is formed over substantially an entire area of the light restriction portion 530. The planar light blocking portion 34 can suitably absorb or reflect light leaking out through an LED non-opposed end surfaces 516d of the light guide plate 516. Therefore, light is effectively blocked from entering the gate flexible board insertion recesses 529.

### Seventh Embodiment

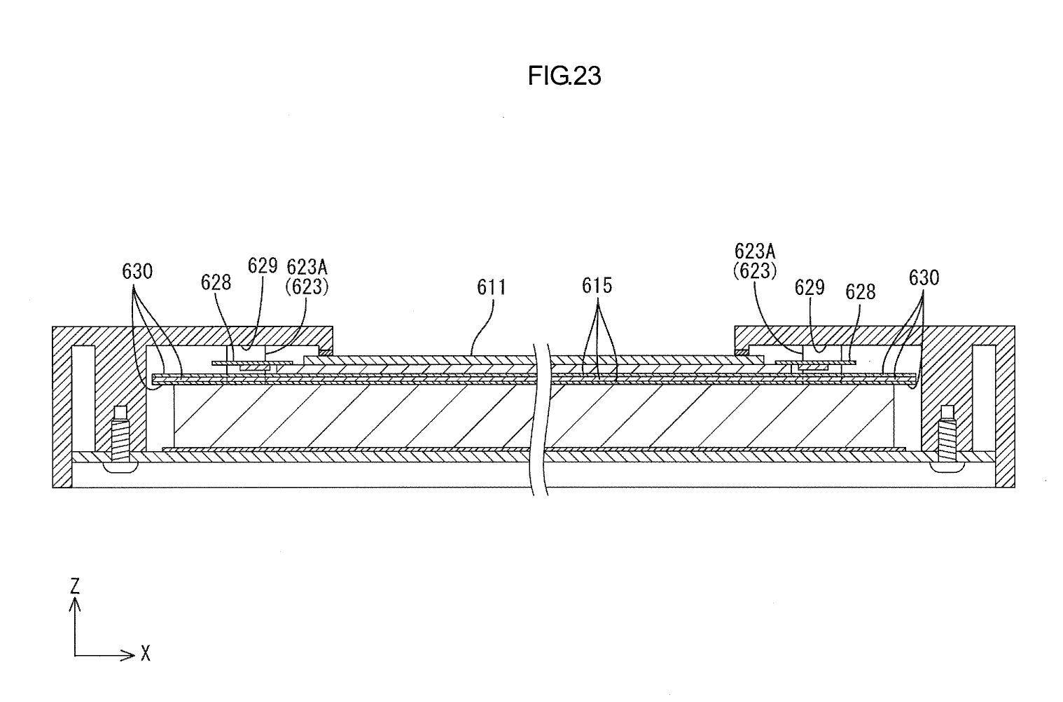

A seventh embodiment according to this invention will be described with reference to FIG. 23. In the seventh embodiment, a gate flexible board 628 is connected to each short-side end of a liquid crystal panel 611. The same structures, operations, and effects as those of the first embodiment will not be described.

As illustrated in FIG. 23, gate flexible boards 628 are connected to two short-side ends of the liquid crystal panel 611, respectively, according to this embodiment. Among light blocking portions 623, light blocking portions 623A on the short sides each include a gate flexible board insertion recess 629 through which the gate flexible board 628 passes. Optical member 615 includes light restriction portions 630 on its two short-side ends, respectively. The light restriction portions 630 are arranged in the respective gate flexible board insertion recesses 629. The gate flexible boards 628, the gate flexible board insertion recesses 629, and the light restriction portions 630 are symmetrically arranged as illustrated in FIG. 23.

### OTHER EMBODIMENTS

The scope of the present invention is not limited to the embodiments described in the above description with reference to the drawings. The following embodiments may be included in the technical scope of the present invention, for example.

(1) In each of the above embodiments, the outer ends of the light restriction portions are located on the outer side with respect to the LED non-opposed end surface of the light guide plate. However, the outer ends of the light restriction portions may be in the same plane with the LED non-opposed end surface of the light guide plate, or may be located on an inner side with respect to the LED non-opposed end surface of the light guide plate.

(2) In each of the above embodiments, the outer ends of the light restriction portions are located on the outer side with respect to the outer ends of the gate flexible boards. However, the outer ends of the light restriction portions may be in the same plane with the outer ends of the gate flexible boards, or may be located on an inner side with respect to the outer ends of the gate flexible boards.

(3) In each of the above embodiments, the outer ends of the light restriction portions are located on the outer side with respect to the outer end of the light blocking portion. However, the outer ends of the light restriction portions may be in the same plane with the outer end of light blocking portion, or may be located inward from the outer end of light blocking portion.

(4) In each of the first and the third embodiments, the size of each light restriction portion in the direction along the end of the liquid crystal panel is larger than or the same as that of each gate flexible board. However, the size of each light restriction portion in the direction along the end of the liquid crystal panel may be smaller than that of each gate flexible board.

(5) In each of the above embodiments (except for the third embodiment), the size of each light restriction portion in the direction along the end of the liquid crystal panel is larger than that of each gate flexible board, and the gate flexible board insertion recesses each have the two different widths. However, the gate flexible board insertion recesses each may have a constant width in its entire area.

(10) In the fourth embodiment, the light restriction portions are included only in the diffuser sheet in the optical member. However, the light restriction portions may be included only in the lens sheet or the reflection type polarizing sheet. Further, the number of the optical sheets including the light restriction portions may be set less than the total number of the optical sheets and more than one.

(7) In the fifth embodiment, the planar light blocking portions are included only in the light restriction portions of the diffuser sheet in the optical member. However, the planar light blocking portions may be included only in the light restriction portions of in the lens sheet or only in the light restriction portions of the reflection type polarizing sheet. Further, the number of the optical sheets including the planar light blocking portions may be set less than the total number of the optical sheets and more than one.

(8) In each of the above embodiments, the light restriction portions are arranged in the respective gate flexible board insertion recesses through which the gate flexible boards pass. However, the light restriction portions may be arranged in the respective source flexible board insertion recesses through which the source flexible boards pass.

(9) In each of the above embodiments, the source flexible boards are connected to one of the long-side end portions of the liquid crystal panel. However, the source flexible boards may be connected to both of the long-side end portions of the liquid crystal panel.

(10) In each of the above embodiments, the gate flexible boards that are the panel connecting members have flexibility. However, panel connecting members having a hard property and not having flexibility may be used.

(11) In each of the above embodiments, the gate flexible boards including the drivers for driving liquid crystals are used as the panel connecting members connected to the end portions of the liquid crystal panel. However, panel connecting members including components other than drivers may be used.

(12) In each of the above embodiments, the LED unit (the LED board) is arranged opposite each long-side end of the light guide plate. However, the LED unit may be arranged opposite each short-side end of the light guide plate.

(13) Other than the above embodiment (12), four LED units (the LED boards) in total including two pairs one of which may be arranged to face the long-side ends of the light guide plate and another one of which may be arranged to face the short-side ends. Further, the LED unit may be arranged so as to face one of the long-side ends or one of the short-side ends of the light guide plate. Three LED units may be arranged so as to face side ends of any three sides of the light guide plate.

(14) In each of the above embodiments, two LED units (the LED boards) are arranged for one side of the light guide plate. However, one LED unit or three or more LED units may be arranged for one side of the light guide plate.

(15) In each of the above embodiments, the power source board is configured to supply power to the LEDs. However, an LED drive board that is configured to supply power to the LEDs may be provided as a separate member from the power source board.

(16) In each of the above embodiments, the main board includes the tuner. However, a tuner board including a tuner may be provided as a separate member from the main board.

(17) In each of the above embodiments, the color filter of the liquid crystal panel includes color portions in three colors, R, G, and B. However, the color filter may include color portions in four or more colors.

(18) In each of the above embodiments, the LED is used as a light source. However, a light source other than the LED, such as organic EL, may be used.

(19) In each of the above embodiments, TFTs are used as the switching components of the liquid crystal display device. However, this invention is applicable to liquid crystal display devices including switching components other than TFTs (e.g., thin film diodes (TFDs)). This invention may be applicable to black-and-white liquid crystal display devices other than color liquid crystal display devices.

(20) In each of the above embodiments, the display device is a liquid crystal display device including a liquid crystal panel as a display panel. However, this invention is applicable to display devices including other types of display panels.

(21) In each of the above embodiments, the television device including a tuner is described. However, this invention is applicable to a display device without a tuner.

### EXPLANATION OF SYMBOLS

10: liquid crystal display device (display device), 11,111,611: liquid crystal panel (display panel), 11c: display surface, 13: frame (holding portion), 14: chassis (holding portion), 15,115,315,415,515,616: optical member, 16,116,316,416,516: light guide plat, 16b: light entrance surface (end surface), 16d,116d,416d,516d: LED non-opposed end surface (end surface), 17: LED (light source), 23,623: light block portion, 23A,123A,623A: light block portion, 28,128,228,628: gate flexible board (panel connecting member), 29,129,229,329,429,529,629: gate flexible board insertion recess (insertion recess), 29a: first insertion recess, 29b,329b: second insertion recess, 30,130,230,330,430,530,630: light restriction portion, 31,331: contact portion (recess edge of the second insertion recess), 32: connect portion, HM: holding member, TV: television device.

1. A display device, comprising:
a light source;
a display panel configured to provide a display using light from the light source;
a panel connecting member connected to an end portion of the display panel and protruding from the end portion of the display panel toward an outer side;
a light guide plate arranged to overlap the display panel on a side opposite to a display surface side of the display panel and arranged such that an end surface of the light guide plate is arranged opposite the light source;
an optical member arranged between the display panel and the light guide plate;
a holding member including a pair of holding portions that houses the light source and the panel connecting member and holds the display panel, the optical member, and the light guide plate from the display surface side and the side opposite to the display surface side;
a light blocking portion arranged to range between one of the pair of the holding portions that is on the display surface side and the light guide plate, the light blocking portion being configured to block at least light being on the outer side with respect to the light blocking portion from directly entering the end portion of the display panel, the light blocking portion including an insertion recess to which the panel connecting member is fitted; and
a light restriction portion provided to the optical member and arranged in the insertion recess, the light restriction portion being configured to restrict light being on the outer side with respect to the light blocking portion from directly entering the end portion of the display panel through the insertion recess.

2. The display device according to claim 1, wherein the light restriction portion has a size larger than a size of the panel connecting member in a direction along the end portion of the display panel.

3. The display device according to claim 2, wherein the insertion recess includes:
a first insertion recess to which the panel connecting member is fitted; and
a second insertion recess to which the light restriction portion is fitted, the second insertion recess having a size larger than a size of the first insertion recess, wherein
the second insertion recess includes a recess edge portion that is in contact with a surface of the light restriction portion facing the panel connecting member.

4. The display device according to claim 3, wherein the light restriction portion is held between the recess edge portion of the second insertion recess and the light guide plate.

5. The display device according to claim 1, wherein an outer end of the light restriction portion is located on the outer side with respect to a protruded distal end of the panel connecting member.

6. The display device according to claim 1, wherein an outer end of the light restriction portion is located on the outer side with respect to an outer end of the light blocking portion.

7. The display device according to claim 6, wherein the outer end of the light restriction portion is located on the outer side with respect to the end surface of the light guide plate.

8. The display device according to claim 1, wherein the light restriction portion has a larger area than the panel connecting member in a view from the display surface side.

9. The display device according to claim 1, wherein the light blocking portion protrudes from the one of the pair of the holding portions arranged on the display surface side toward the light guide plate, a protruded end surface of the light blocking portion is in contact with the light guide plate.

10. The display device according to claim 1, wherein the optical member includes a plurality of optical members that are placed on each other, each of the optical members including the light restriction portion.

11. The display device according to claim 1, wherein the light restriction portion is integrally included in the optical member as a part thereof.

12. The display device according to claim 1, wherein the light restriction portion protrudes from an end of the optical member to the outer side in a cantilever shape.

13. The display device according to claim 1, wherein
the panel connecting member includes a plurality of panel connecting members;
the light restriction portion includes a plurality of light restriction portions; and
the insertion recess includes a plurality of insertion recesses, wherein
the panel connecting members, the light restriction portions, and the insertion recesses are arranged at intervals along the end portion of the display panel, and
the display device further comprising a connect portion arranged on the outer side with respect to the light blocking portion, the connect portion connecting the light restriction portions adjacent to each other.

14. The display device according to claim 1, wherein the display panel is a liquid crystal panel including a pair of substrates with liquid crystals sealed therebetween.

15. A television device comprising the display device according to claim 1.
